(19) United States
(12) Patent Application Publication
(10) Pub. No.: US 2025/0091082 A1
(43) Pub. Date: Mar. 20, 2025

(54) DISPENSING APPARATUS

(71) Applicant: Samsung Display Co., Ltd., Yongin-Si (KR)

(72) Inventors: BYUNGSU KIM, Yongin-si (KR); JAEGI YOO, Yongin-si (KR); KIHYUN KIM, Yongin-si (KR); SEUNGMIN HONG, Yongin-si (KR)

(21) Appl. No.: 18/777,552

(22) Filed: Jul. 19, 2024

(30) Foreign Application Priority Data
Sep. 20, 2023 (KR) 10-2023-0125442
Feb. 8, 2024 (KR) 10-2024-0019848

(51) Int. Cl. B05C 1/00; B05B 3/02; B05C 5/02

(52) U.S. Cl. CPC B05C 1/006; B05B 3/025; B05C 5/0225

(57) ABSTRACT

Provided is a dispensing device including a rotation drive part, a curved rail part connected to the rotation drive part in a first direction, a curved movement part coupled to a lower portion of the curved rail part, and a nozzle connected to the curved movement part, wherein the nozzle may pivot or rotate around a tip of the nozzle.

### CROSS-REFERENCE TO RELATED APPLICATIONS

This U.S. non-provisional patent application claims priority, under 35 U.S.C. § 119, to Korean Patent Application No. 10-2023-0125442 filed on Sep. 20, 2023, and Korean Patent Application No. 10-2024-0019848 filed on Feb. 8, 2024, the entire contents of which are hereby incorporated by reference.

### BACKGROUND

The present disclosure herein relates to a dispensing device, a discharge device, and a manufacturing method of a display panel.

In general, a display device includes a display panel for displaying an image. The display panel may include a first substrate, a light-emitting element layer disposed on the first substrate, and a second substrate disposed on the first substrate to cover the light-emitting element layer. The light-emitting element layer may include a plurality of light-emitting elements, and the light-emitting elements may generate predetermined light to display the image.

The second substrate may have a smaller width than that of the first substrate, such that an edge of the first substrate and an edge of the second substrate may form a step. The edge of the first substrate and the edge of the second substrate may define an edge of the display panel. In order to prevent a light leakage phenomenon in which light generated in the light-emitting element layer is emitted through the edge of the display panel, a light-blocking layer for absorbing the light may be disposed on the edge of the display panel.

In order to form the light-blocking layer, a dispensing device may be used. The dispensing device may apply a resin having a black color to the edge of the display panel. The dispensing device, capable of facilitating alignment of a nozzle that discharges the resin, is required to apply the resin to the edge of the display panel.

### SUMMARY

The present disclosure provides a dispensing device for aligning a nozzle more easily.

The present disclosure also provides a discharge device capable of easily discharging ink and preventing damage and malfunction of a drive part, and provides a manufacturing method of a display panel using the same.

An embodiment of the inventive concept provides a dispensing device including a rotation drive part, a curved rail part connected to the rotation drive part in a first direction, a curved movement part coupled to a lower portion of the curved rail part, and a nozzle connected to the curved movement part, wherein the nozzle rotates with respect to a tip of the nozzle.

In an embodiment of the inventive concept, a dispensing device includes a nozzle drive part and a nozzle connected to the nozzle drive part, wherein the nozzle drive part rotates the nozzle with respect to a tip of the nozzle.

In an embodiment of the inventive concept, a discharge device includes a drive part, a discharge part disposed under the drive part and configured to discharge ink according to driving power of the drive part, and an insulation part disposed between the drive part and the discharge part, a direction in which the drive part, the discharge part, and the insulation part are arranged is defined as one direction, and a thickness of the insulation part in the one direction is smaller than a width of the insulation part in a direction perpendicular to the one direction.

In an embodiment of the inventive concept, a manufacturing method of a display panel includes providing, on a stage, a lower substrate, and an upper substrate having a smaller width than the lower substrate and disposed on the lower substrate, pointing a discharge device toward a step portion formed by an edge of the lower substrate and an edge of the upper substrate, and discharging ink from the discharge device to the step portion, the discharge device includes a drive part, a discharge part disposed under the drive part and configured to discharge ink according to driving power of the drive part, and an insulation part disposed between the drive part and the discharge part, wherein the drive part, the discharge part, and the insulation part are arranged in an extending direction, and a thickness of the insulation part in the extending direction is smaller than a width of the insulation part in a direction perpendicular to the extending direction.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a perspective view illustrating the front of a dispensing device according to an embodiment of the inventive concept;

FIG. 2 is a perspective view illustrating the rear of a dispensing device according to an embodiment of the inventive concept;

FIG. 3 is a side view of a dispensing device, in which the dispensing device illustrated in FIG. 1 is viewed from a second direction;

FIG. 4 is a perspective view of a first supporting plate, first and second drive parts, rail parts, and a connection plate illustrated in FIGS. 1 to 3;

FIG. 5 is a plan view of the first supporting plate, the first and second drive parts, the rail parts, and the connection plate illustrated in FIG. 4;

FIG. 6 is a plan view illustrating the first and second drive parts and the first to fourth rail parts of FIG. 5 where the connection plate is separated from the first to fourth rail parts;

FIG. 7 is a perspective view of first and second drive parts and first to fourth rail parts illustrated in FIG. 6;

FIG. 8 is a perspective view of the front of a second rail part, in which the second rail part illustrated in FIG. 7 is separately illustrated;

FIG. 9 is a perspective view of the front of a fourth rail part, in which the fourth rail part illustrated in FIG. 7 is separately illustrated;

FIG. 10 is a perspective view of the rear of the second rail part illustrated in FIG. 8;

FIG. 11 is a perspective view of the rear of the fourth rail part illustrated in FIG. 9;

FIG. 12 is a perspective view of a connection plate, a third drive part, first and second movement parts, and a vertical guide part illustrated in FIGS. 1 to 3;

FIG. 13 is a side view of a connection plate, a third drive part, first and second movement parts, and a vertical guide part, in which the connection plate, the third drive part, the first and second movement parts, and the vertical guide part illustrated in FIG. 12 are viewed from a second direction;

FIG. 14 is a drawing illustrating a movement state of the first movement part and the second movement part illustrated in FIG. 13;

FIG. 15 is a drawing illustrating a connection state of a first stage, illustrated in FIG. 4, and a second stage illustrated in FIG. 13;

FIG. 16 is a perspective view of a rotation drive part, a curved rail part, a curved movement part, and a nozzle illustrated in FIGS. 1 to 3;

FIG. 17 is a side view of a rotation drive part, a curved rail part, a curved movement part, and a nozzle, in which the rotation drive part, the curved rail part, the curved movement part, and the nozzle illustrated in FIG. 16 are viewed from a second direction;

FIG. 18 is a drawing illustrating a movement state of a curved movement part with respect to a curved rail part;

FIG. 19A is a cross-sectional view taken along line I-I′ of FIG. 16;

FIGS. 19B and 19C are drawings illustrating a movement state of a curved movement part with respect to a curved rail part;

FIG. 20 is a drawing illustrating the movement of the nozzle illustrated in FIGS. 17 and 18;

FIG. 21 is a drawing illustrating a connection state of a nozzle drive part, illustrated in FIG. 17, and the second movement part illustrated in FIG. 13;

FIG. 22 is a drawing illustrating a connection state of a nozzle drive part, illustrated in FIG. 17, and a second stage illustrated in FIG. 13;

FIG. 23 is a drawing schematically illustrating a cross-section of a display panel manufactured by using the dispensing device illustrated in FIGS. 1 to 3;

FIGS. 24A to 24C are drawings illustrating a method of forming a light-blocking layer by using a dispensing device according to an embodiment of the inventive concept; and

FIGS. 25A and 25B are drawings illustrating a method of forming a light-blocking layer by using a nozzle of a dispensing device according to Comparative Example.

FIG. 26 is a drawing illustrating a nozzle according to another embodiment of the inventive concept;

FIG. 27 is a perspective view of the nozzle illustrated in FIG. 26;

FIG. 28 is a side view of the discharge device, illustrated in FIG. 26, disposed to be parallel to a third direction;

FIG. 29 is a drawing of a discharge device rotated about a third direction such that a side surface of an ink inlet, illustrated in FIG. 28, is shown;

FIG. 30 is a side view of the discharge device of FIG. 29 where a conductive part and a connecting part are removed therefrom;

FIG. 31 is a drawing schematically illustrating internal configuration of the discharge device illustrated in FIG. 28;

FIG. 32 is an exploded perspective view of the discharge device, illustrated in FIG. 28, where an insulation part and a conductive part are separated therefrom;

FIG. 33A is an enlarged perspective view of the insulation part illustrated in FIG. 32;

FIG. 33B is a perspective view illustrating a rear surface of the insulation part illustrated in FIG. 33A;

FIGS. 34A to 34D are drawings illustrating a manufacturing method of a display device using a dispensing device including the discharge device illustrated in FIG. 26;

FIG. 35A shows the discharge amount of ink discharged from a pneumatic discharge device according to pressure;

FIG. 35B shows the discharge amount of ink discharged from a discharge device, according to an embodiment of the inventive concept, according to the number of rotations per minute of a drive part;

FIG. 36A is a diagram showing the discharge amount of ink and the amount of increase in the discharged ink in a table when the number of rotations per minute of a motor of a motorized discharge device and the pressure of a pneumatic discharge device are increased;

FIG. 36B is a diagram showing the values on the table of FIG. 36A in a graph; and

FIGS. 37 and 38 are drawings illustrating components of insulation parts according to another embodiment of the inventive concept.

### DETAILED DESCRIPTION

In this specification, it will be understood that when an element (or a region, a layer, a portion, or the like) is referred to as being “on”, “connected to” or “coupled to” another element, it may be directly disposed on, connected or coupled to the other element, or intervening elements may be disposed therebetween.

Like reference numerals or symbols refer to like elements throughout. In the drawings, the thickness, the ratio, and the size of the element are exaggerated for effective description of the technical contents.

As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section without being limited to a specific order. Thus, a first element, component, region, layer or section discussed below could be termed a second element, component, region, layer or section without departing from the scope of the inventive concept. Similarly, a second element, component, region, layer or section may be termed a first element, component, region, layer or section. As used herein, the singular forms, “a”, “an” and “the” are intended to include the plural forms as well, unless the context clearly indicates otherwise.

Also, terms of “below”, “on lower side”, “above”, “on upper side”, or the like may be used to describe the relationships of the elements illustrated in the drawings. These terms have relative concepts and are described on the basis of the directions indicated in the drawings.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be further understood that the terms “includes” and/or “have”, when used in this specification, specify the presence of stated features, integers, steps, operations, elements, components, and/or groups thereof, but do not preclude the presence or addition of one or more other features, integers, steps, operations, elements, components, and/or groups thereof.

Hereinafter, embodiments of the inventive concept are described with reference to the accompanying drawings.

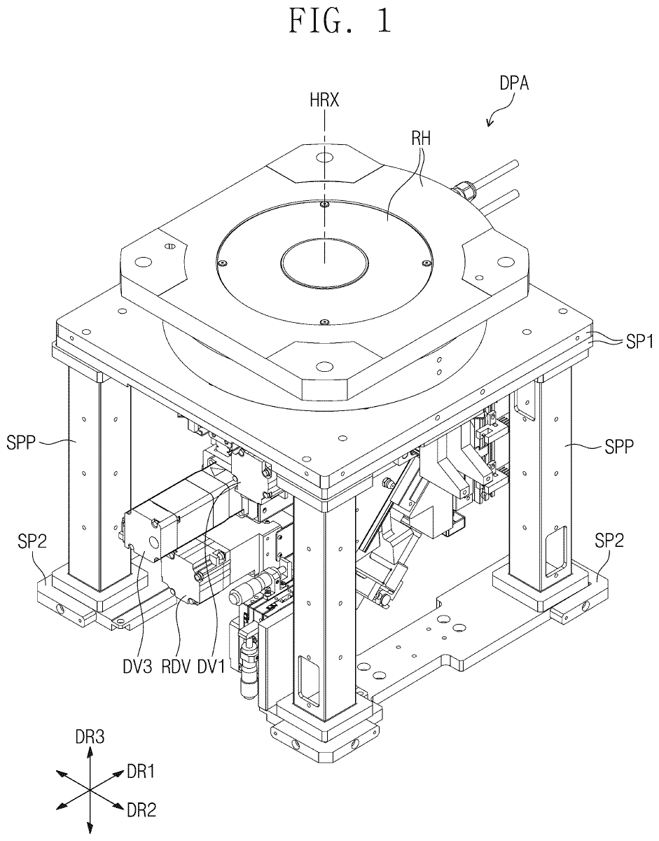

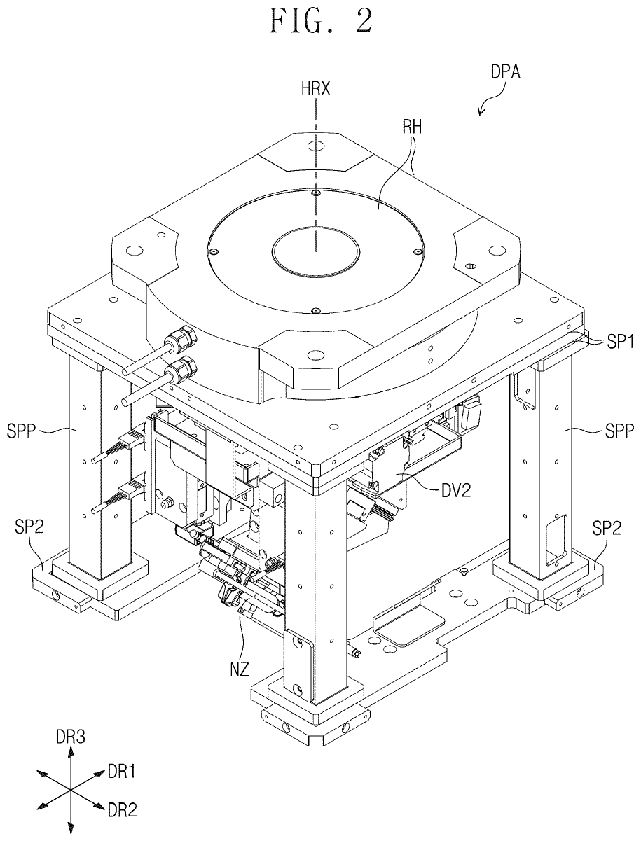

FIG. 1 is a perspective view illustrating the front of a dispensing device according to an embodiment of the inventive concept. FIG. 2 is a perspective view illustrating the rear of a dispensing device according to an embodiment of the inventive concept.

Referring to FIGS. 1 and 2, a dispensing device DPA may include a rotation head RH, a first supporting plate SP1, a plurality of second supporting plates SP2, a plurality of supporting pillars SPP, first, second, and third drive parts DV1, DV2, and DV3, and a rotation drive part RDV.

The rotation head RH may have a flat surface defined by a first direction DR1 and a second direction DR2 crossing the first direction DR1. The rotation head RH may rotate about a head rotation axis HRX extending in a third direction DR3 crossing the plane defined by the first and second directions DR1 and DR2.

The third direction DR3 may be substantially perpendicular to the plane defined by the first and second directions DR1 and DR2. In this specification, “when viewed on a plane” may refer to a state when viewed from the third direction DR3. The first, second, and third directions DR1, DR2, and DR3 may each be defined to include both the positive and the negative directions.

The first supporting plate SP1 may be disposed under the rotation head RH to be connected to the rotation head RH. When the rotation head RH rotates, the first supporting plate SP1 may also rotate together with the rotation head RH.

The first supporting plate SP1 may have a flat surface defined by the first and second directions DR1 and DR2. When viewed on a plane, the first supporting plate SP1 may have a quadrilateral shape, but the shape of the first supporting plate SP1 is not limited thereto. For example, the first supporting plate SP1 may include two plates stacked in the third direction DR3, but is not limited thereto, and may include only one plate.

The second supporting plates SP2 may be disposed under the first supporting plate SP1. Each one of the second supporting plates SP2 may have a flat surface parallel to the plane defined by the first and second directions DR1 and DR2. The second supporting plates SP2 may extend longer in the first direction DR1 than in the second direction DR2.

The second supporting plates SP2 may be spaced apart from each other in the second direction DR2. When viewed on a plane, two second supporting plates SP2 may be respectively adjacent to both sides of the first supporting plate SP1 that are opposed to each other in the second direction DR2. The two second supporting plates SP2 are exemplarily illustrated, but the number of the second supporting plates SP2 is not limited thereto.

The supporting pillars SPP may be disposed between the first supporting plate SP1 and the second supporting plates SP2. The supporting pillars SPP may be connected to the first supporting plate SP1 and the second supporting plates SP2.

The supporting pillars SPP may extend in the third direction DR3. The supporting pillars SPP may each have a shape of a quadrangular pillar extending in the third direction DR3, but the shape of the supporting pillars SPP is not limited thereto.

The supporting pillars SPP may be respectively adjacent to four corners of the first supporting plate SP1. The supporting pillars SPP may be respectively adjacent to both sides of the second supporting plates SP2 that are opposed to each other in the first direction DR1.

When viewed from the second direction DR2, the first, second, and third drive parts DV1, DV2, and DV3 and the rotation drive part RDV may be disposed between the first supporting plate SP1 and the second supporting plates SP2. The first, second, and third drive parts DV1, DV2, and DV3 and the rotation drive part RDV may be disposed between the supporting pillars SPP.

The first drive part DV1 and the second drive part DV2 may be disposed under the first supporting plate SP1 to be connected to the first supporting plate SP1. The third drive part DV3 may be disposed under the first and second drive parts DV1 and DV2. The rotation drive part RDV and a nozzle NZ may be disposed under the third drive part DV3.

More configurations of the first, second, and third drive parts DV1, DV2, and DV3 and the rotation drive part RDV may be described in detail as follows. The dispensing device DPA may further include a number of components, other than the first, second, and third drive parts DV1, DV2, and DV3, and the rotation drive part RDV previously described, and more particular components of the dispensing device DPA will be also described in detail as follows.

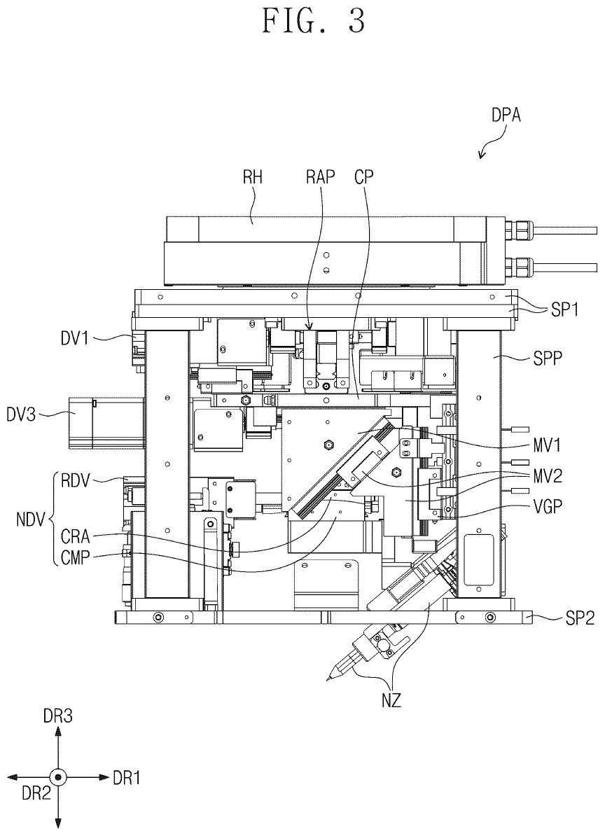

FIG. 3 is a side view of a dispensing device, in which the dispensing device illustrated in FIG. 1 is viewed from a second direction.

Referring to FIGS. 1, 2, and 3, the dispensing device DPA may include, in addition to the components described with reference to FIGS. 1 and 2, a rail part RAP, a connection plate CP, a first movement part MV1, a second movement part MV2, a vertical guide part VGP, a curved rail part CRA, and a curved movement part CMP.

The rail part RAP may be disposed under the first supporting plate SP1. The rail part RAP may be provided substantially in plurality, and connected to the first supporting plate SP1. Hereinafter, the rail part RAP is referred to as plural.

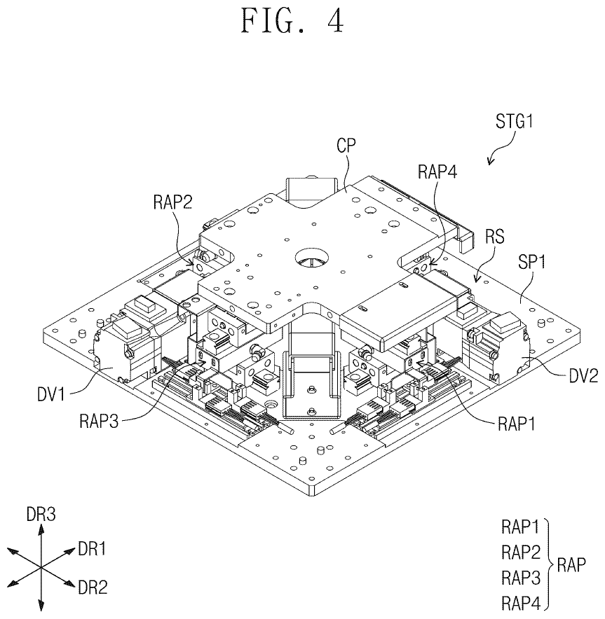

The rail parts RAP may be disposed on the same layer as the layer on which the first drive part DV1 and the second drive part DV2 are disposed. Substantially, the first and second drive parts DV1 and DV2 may each be connected to a corresponding rail part RAP among the plurality of rail parts RAP, and this composition will be described in detail with reference to FIGS. 4 to 7 as follows.

The connection plate CP may be disposed under the first and second drive parts DV1 and DV2. In addition, the connection plate CP may be disposed under the rail parts RAP. The connection plate CP may be connected to the rail parts RAP. A perspective view of the connection plate CP and the rail parts RAP, connected to each other, is illustrated in FIG. 4.

The first movement part MV1, the second movement part MV2, and the vertical guide part VGP may be disposed under the connection plate CP. When viewed from a second direction DR2, the first movement part MV1 may be disposed at the center portion of a space between the supporting pillars SPP. The third drive part DV3 may be spaced apart from the first movement part MV1 in a first direction DR1. When viewed from the second direction DR2, a portion of the third drive part DV3 may be disposed in the outside of the supporting pillar SPP adjacent thereto.

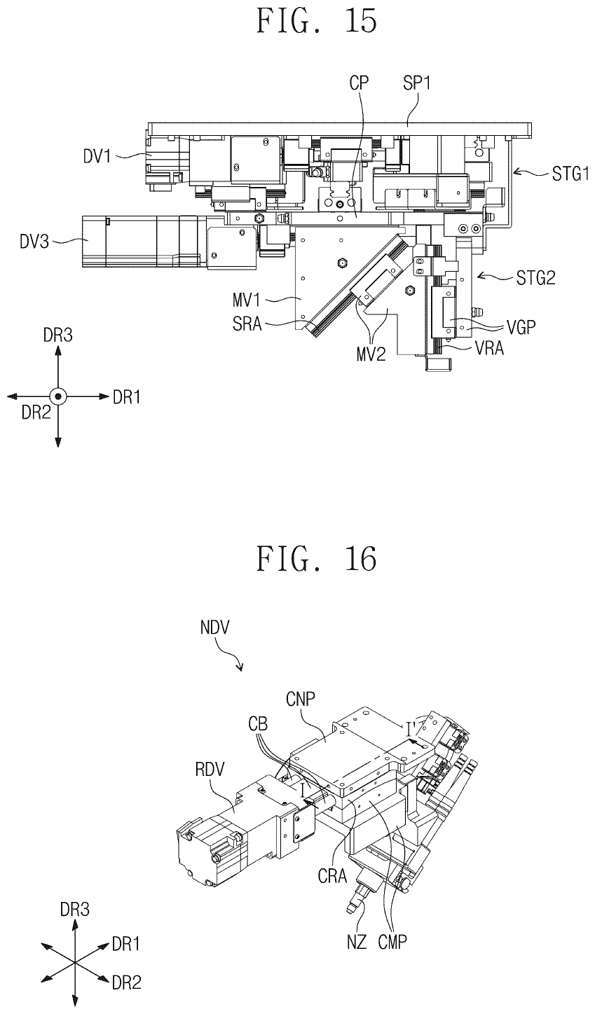

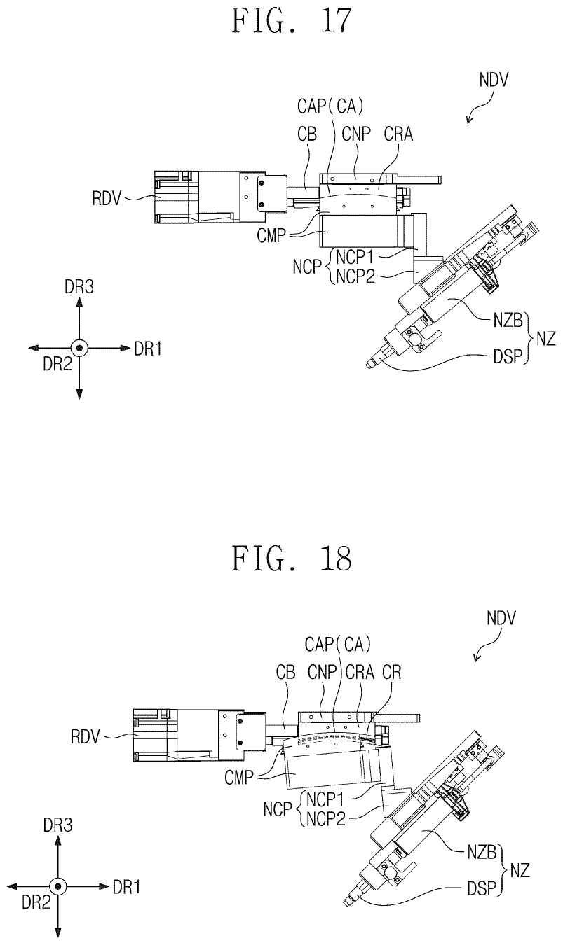

The third drive part DV3 may be connected to the connection plate CP, and the first movement part MV1 may be connected to the third drive part DV3. The second movement part MV2 may be coupled to the first movement part MV1 and the vertical guide part VGP. This configuration will be described in more detail with reference to FIGS. 12 and 13 later.

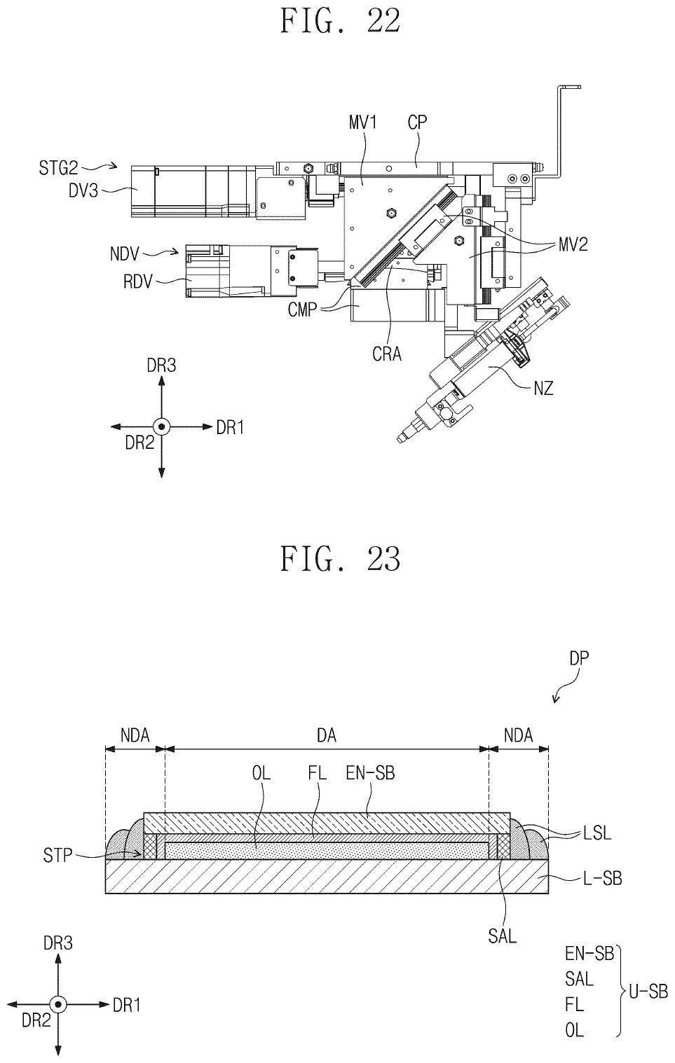

The curved rail part CRA may be spaced apart from the rotation drive part RDA in the first direction DR1. The curved movement part CMP may be disposed under the curved rail part CRA. The curved rail part CRA may be connected to the rotation drive part RDV and the second movement part MV2, and the curved movement part CMP may be coupled to the curved rail part CRA. This configuration will be described in detail with reference to FIGS. 16 to 20.

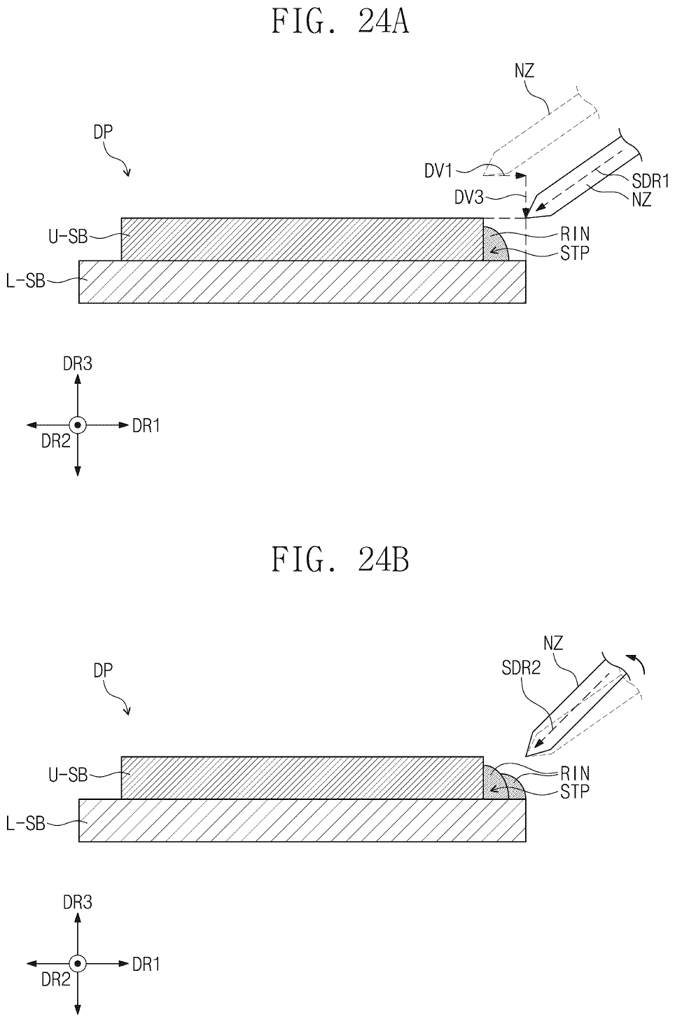

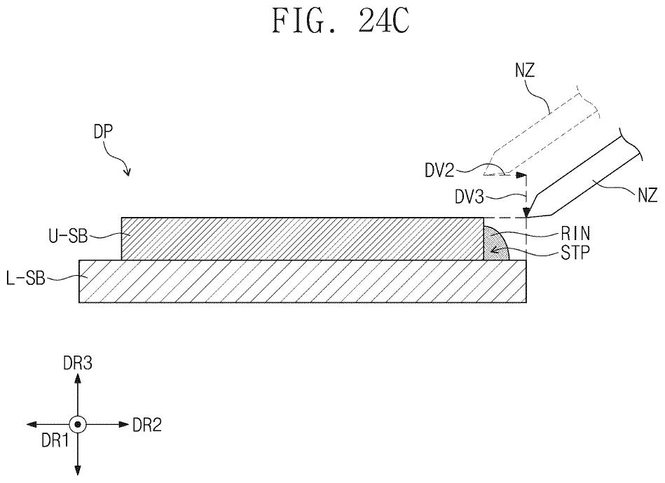

The nozzle NZ may be connected to the curved movement part CMP. The nozzle NZ may be disposed to be inclined with respect to the first direction DR1. The rotation drive part RDA, the curved rail part CRA, and the curved movement part CMP may be defined as a nozzle drive part NDV. That is, the nozzle drive part NDV may include the rotation drive part RDV, the curved rail part CRA, and the curved movement part CMP. The nozzle NZ may be connected to the nozzle drive part NDV and rotatably moved by the nozzle drive part NDV, and this configuration will be described in detail with reference to FIGS. 17 and 18 later.

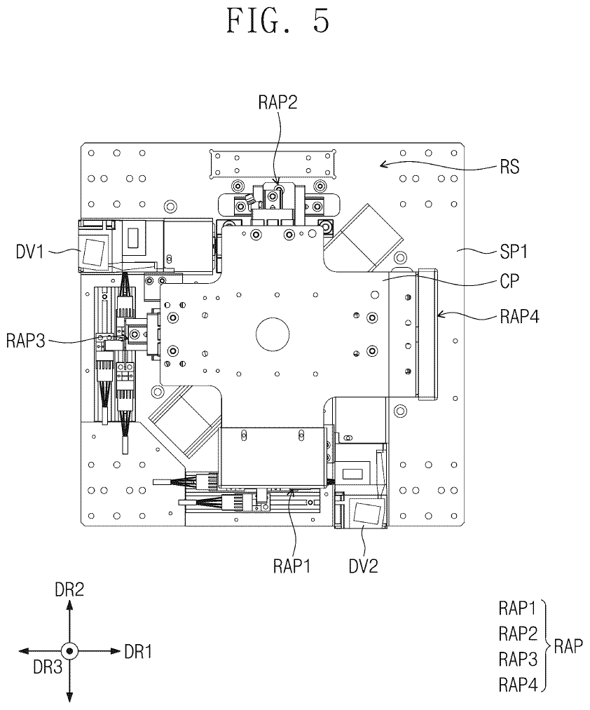

FIG. 4 is a perspective view of the first supporting plate, the first and second drive parts, the rail parts, and the connection plate illustrated in FIGS. 1 to 3. FIG. 5 is a plan view of the first supporting plate, the first and second drive parts, the rail parts, and the connection plate illustrated in FIG. 4.

FIG. 4 exemplarily illustrates that the first supporting plate SP1, the first and second drive parts DV1 and DV2, the rail parts RAP, and the connection plate CP are coupled to each other.

For the convenience of description, FIG. 4 illustrates that the first supporting plate SP1, the first and second drive parts DV1 and DV2, the rail parts RAP, and the connection plate CP, illustrated in FIGS. 1 to 3, are reversed. Therefore, it is illustrated that the first and second drive parts DV1 and DV2, the rail parts RAP, and the connection plate CP are disposed facing upwards, and disposed on the first supporting plate SP1. Hereinafter, a surface of the first supporting plate SP1 illustrated in FIG. 4 is referred to as a rear surface RS.

Referring to FIGS. 4 and 5, the rail parts RAP may be disposed on the rear surface RS of the first supporting plate SP1. When viewed on a plane, the rail parts RAP may be respectively adjacent to both sides of the first supporting plate SP1 that are opposed to each other in a first direction DR1, and both sides of the first supporting plate SP1 that are opposed to each other in a second direction DR2.

The rail parts RAP may be coupled onto the rear surface RS of the first supporting plate SP1 to move in the first direction DR1 and the second direction DR2. This structure of the rail parts RAP will be described in detail as follows.

The rail parts RAP may include a first rail part RAP1, a second rail part RAP2, a third rail part RAP3, and a fourth rail part RAP4. The first rail part RAP1 may be spaced apart from the second rail part RAP2 in the second direction DR2. The third rail part RAP3 may be spaced apart from the fourth rail part RAP4 in the first direction DR1.

The first rail part RAP1 and the second rail part RAP2 may be respectively adjacent to the two edges of the first supporting plate SP1 that extend in the first direction DR1. The third rail part RAP3 and the fourth rail part RAP4 may be adjacent to the two edges of the first supporting plate SP1 that extend in the second direction DR2.

The connection plate CP may have a cross shape. The connection plate CP may be disposed on the first to fourth rail parts RAP1 to RAP4 to be connected to the first to fourth rail parts RAP1 to RAP4. The first to fourth rail parts RAP1 to RAP4 may move in the first direction DR1 and in the second direction DR2. As the first to fourth rail parts RAP1 to RAP4 move in the first direction DR1 and in the second direction DR2, the connection plate CP may move in the first direction DR1 and in the second direction DR2.

When viewed on a plane, portions of the second and third rail parts RAP2 and RAP3 may not be covered by the connection plate CP, and may be positioned between the connection plate CP and an edge o the first supporting plate SP1 when viewed on a plane. In contrast, the first and fourth rail parts RAP1 and RAP4 may be covered by the connection plate CP, and may thus not be visible when viewed on a plane.

The first drive part DV1 and the second drive part DV2 may be disposed on the rear surface RS of the first supporting plate SP1. The first drive part DV1 and the second drive part DV2 may be connected to the rear surface RS of the first supporting plate SP1.

The first drive part DV1 may be adjacent to one side of the first supporting plate SP1 that extends in the second direction DR2. The second drive part DV2 may be adjacent to one side of the first supporting plate SP1 that extends in the first direction DR1.

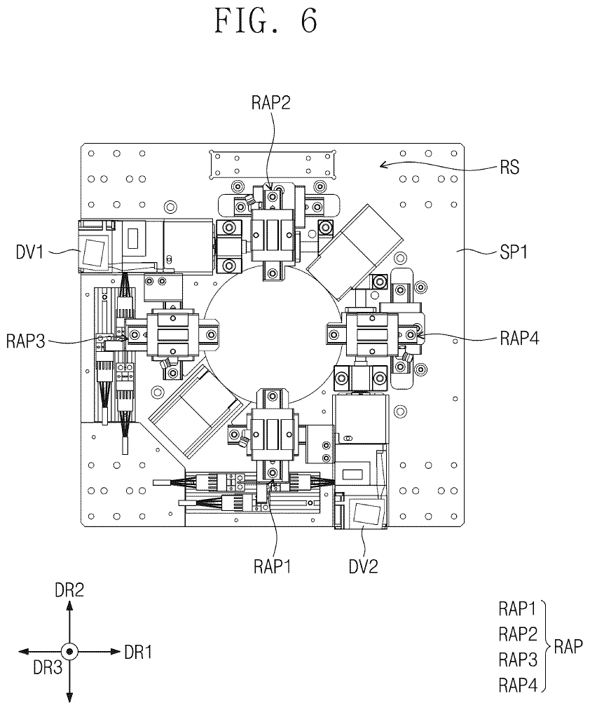

FIG. 6 is a plan view of the first and second drive parts and the first to fourth rail parts, in which the connection plate is separated from the first to fourth rail parts illustrated in FIG. 5.

Referring to FIG. 6, the first drive part DV1 may extend in a first direction DR1, and may be adjacent to the third rail part RAP3 in a second direction DR2. The first drive part DV1 may extend in the first direction DR1 between an edge of the first supporting plate SP1 and the second rail part RAP2 to be adjacent to and connected to the second rail part RAP2.

The second drive part DV2 may extend in the second direction DR2, and may be adjacent to the first rail part RAP1 in the first direction DR1. The second drive part DV2 may extend in the second direction DR2 between an edge of the first supporting plate SP1 and the fourth rail part RAP4 to be adjacent to and connected to the fourth rail part RAP4.

The connection plate CP may be connected to the first and second drive parts DV1 and DV2 through the second and fourth rail parts RAP2 and RAP4.

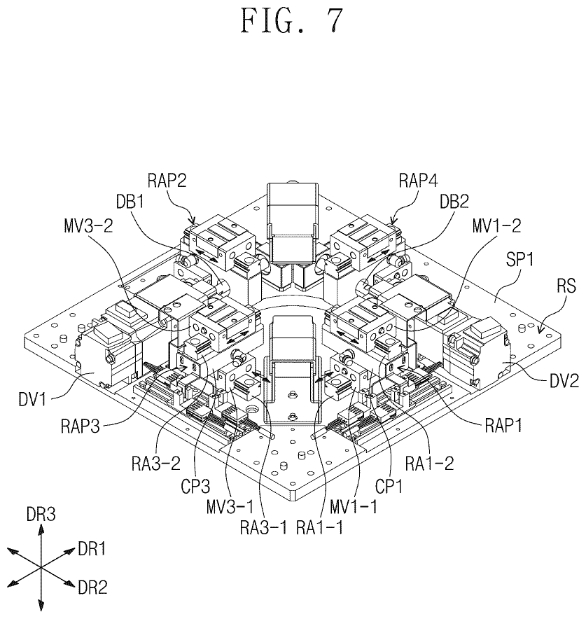

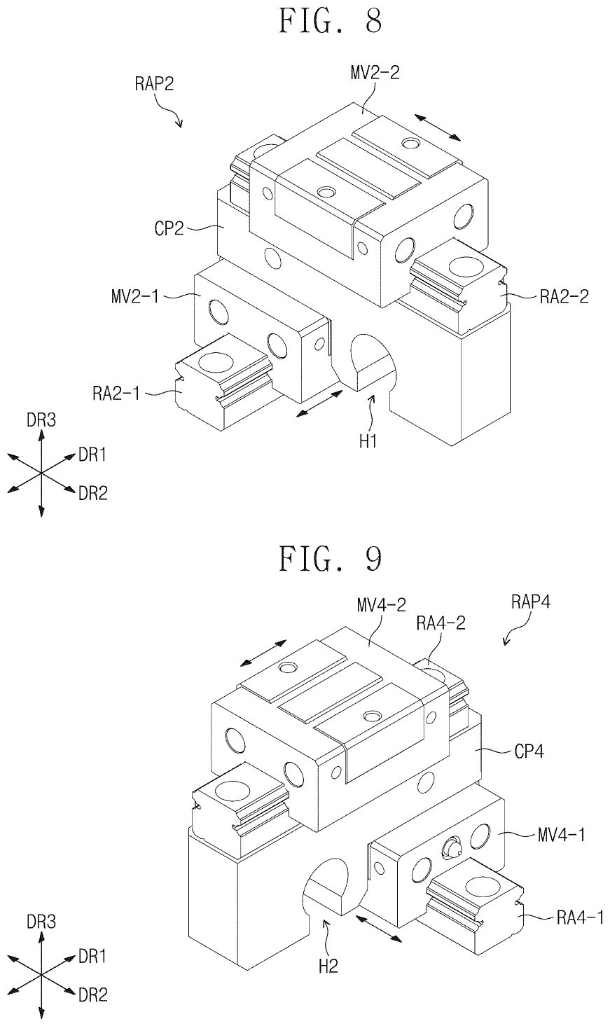

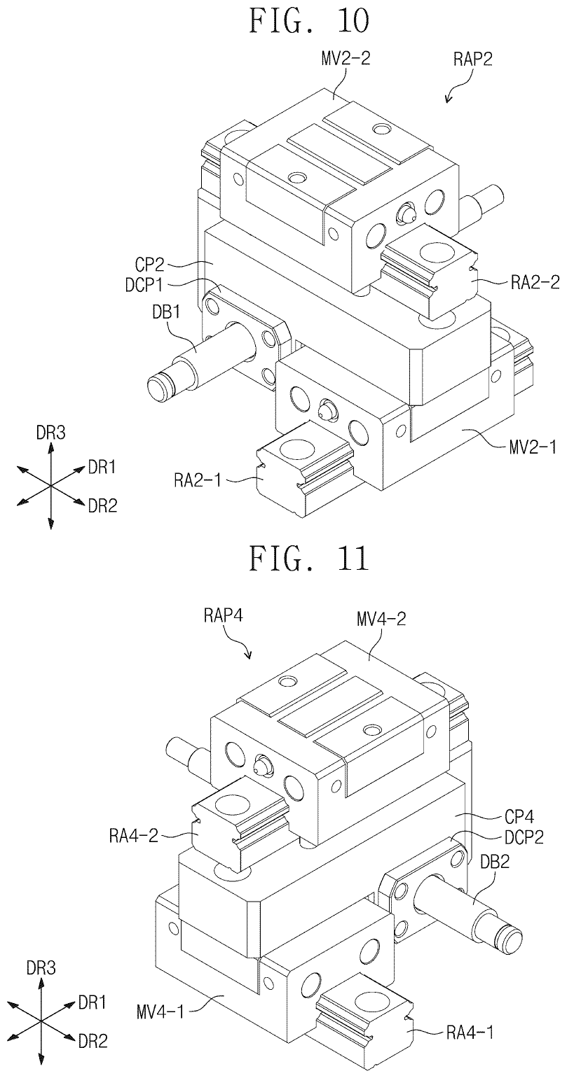

FIG. 7 is a perspective view of the first and second drive parts and the first to fourth rail parts RAP1, RAP2, RAP3, RAP4 illustrated in FIG. 6. FIG. 8 is a perspective view of the front of a second rail part RAP2, in which the second rail part RAP2 of FIG. 7 is separately illustrated. FIG. 9 is a perspective view of the front of a fourth rail part RAP4, in which the fourth rail part RAP4 of FIG. 7 is separately illustrated.

Referring to FIGS. 4 and 7, the first rail part RAP1 may include a (1-1)-th rail RA1-1, a (1-1)-th movement pat MV1-1, a first connection part CP1, a (1-2)-th rail RA1-2, and a (1-2)-th movement part MV1-2.

Hereinafter in this specification, moving in a first direction DR1, moving in a second direction DR2, and moving in a third direction DR3 may each refer to moving in both ways.

The (1-1)-th rail RA1-1 may be disposed on the rear surface RS of the first supporting plate SP1 to be connected to the first supporting plate SP1. The (1-1)-th rail RA1-1 may extend in the first direction DR1. The (1-1)-th movement part MV1-1 may be disposed on the (1-1)-th rail RA1-1, and coupled to the (1-1)-th rail RA1-1 to move along the (1-1)-th rail RA1-1. The (1-1)-th movement part MV1-1 may move in the first direction DR1 along the (1-1)-th rail RA1-1.

The first connection part CP1 may extend in the second direction DR2, and may be disposed on the (1-1)-th movement part MV1-1 to be connected to the (1-1)-th movement part MV1-1. The (1-2)-th rail RA1-2 may extend in the second direction DR2, and may be disposed on the first connection part CP1 to be connected to the first connection part CP1.

The (1-2)-th movement part MV1-2 may be disposed on the (1-2)-th rail RA1-2, and coupled to the (1-2)-th rail RA1-2 to move along the (1-2)-th rail RA1-2. The (1-2)-th movement part MV1-2 may move in the second direction DR2 along the (1-2)-th rail RA1-2. The connection plate CP, illustrated in FIG. 5, may be disposed on the (1-2)-th movement part MV1-2 to be connected to the (1-2)-th movement part MV1-2.

When the (1-1)-th movement part MV1-1 moves in the first direction DR1, the first connection part CP1, the (1-2)-th rail RA1-2, and the (1-2)-th movement part MV1-2 may move in the first direction DRI together with the (1-1)-th movement part MV1-1.

According to this configuration of the first rail part RAP1, the first rail part RAP1 may move in the first direction DRI and in the second direction DR2. Therefore, the connection plate CP, connected to the first rail part RAP1, may also move in the first direction DR1 and in the second direction DR2.

In particular, when the (1-1)-th movement part MV1-1 moves in the first direction DR1, the first connection part CP1, the (1-2)-th rail RA1-2, and the (1-2)-th movement part MV1-2 may move in the first direction DR1 together with the (1-1)-th movement part MV1-1, so that the connection plate CP connected to the (1-2)-th movement part MV1-2 may also move in the first direction DR1. When the (1-2)-th movement part MV1-2 moves in the second direction DR2, the connection plate CP connected to the (1-2)-th movement part MV1-2 may move in the second direction DR2.

Referring to FIGS. 4, 7, and 8, the second rail part RAP2 may be different from the first rail part RAP1 partially in shape, but may have substantially the same configuration as that of the first rail part RAP1 otherwise. The second rail part RAP2 may include a (2-1)-th rail RA2-1, a (2-1)-th movement part MV2-1, a second connection part CP2, a (2-2)-th rail RA2-2, and a (2-2)-th movement part MV2-2.

The (2-1)-th rail RA2-1 may be disposed on the rear surface RS of the first supporting plate SP1 to be connected to the first supporting plate SP1. The (2-1)-th rail RA2-1 may extend in the first direction DR1. The (2-1)-th movement part MV2-1 may be disposed on the (2-1)-th rail RA2-1, and coupled to the (2-1)-th rail RA2-1 to move along the (2-1)-th rail RA2-1. The (2-1)-th movement part MV2-1 may move in the first direction DRI along the (2-1)-th rail RA2-1.

The second connection part CP2 may extend in the second direction DR2, and may be disposed on the (2-1)-th movement part MV2-1 to be connected to the (2-1)-th movement part MV2-1. The (2-2)-th rail RA2-2 may extend in the second direction DR2, and may be disposed on the second connection part CP2 to be connected to the second connection part CP2.

When viewed on a plane, a first hole H1 extending in the first direction DR1 may be defined in a portion of the second connection part CP2 that is not overlapping the (2-1)-th movement part MV2-1. A first drive bar DB1 illustrated in FIG. 7 may be connected to the first drive part DV1. The first drive bar DB1 may extend in the first direction DR1 in the first hole H1 illustrated in FIG. 8. To clearly illustrate the first hole H1, the first drive bar DB1 is omitted in FIG. 8.

The (2-2)-th movement part MV2-2 may be disposed on the (2-2)-th rail RA2-2, and coupled to the (2-2)-th rail RA2-2 to move along the (2-2)-th rail RA2-2. The (2-2)-th movement part MV2-2 may move in the second direction DR2 along the (2-2)-th rail RA2-2. The connection plate CP illustrated in FIG. 5 may be disposed on the (2-2)-th movement part MV2-2 to be connected to the (2-2)-th movement part MV2-2.

When the (2-1)-th movement part MV2-1 moves in the first direction DR1, the second connection part CP2, the (2-2)-th rail RA2-2, and the (2-2)-th movement part MV2-2 may move in the first direction DRI together with the (2-1)-th movement part MV2-1.

According to this configuration of the second rail part RAP2, the second rail part RAP2 may move in the first direction DR1 and in the second direction DR2. Therefore, the connection plate CP, connected to the second rail part RAP2, may also move in the first direction DRI and in the second direction DR2.

In particular, when the (2-1)-th movement part MV2-1 moves in the first direction DR1, the second connection part CP2, the (2-2)-th rail RA2-2, and the (2-2)-th movement part MV2-2 may move in the first direction DR1 together with the (2-1)-th movement part MV2-1, so that the connection plate CP connected to the (2-2)-th movement part MV2-2 may also move in the first direction DR1. When the (2-2)-th movement part MV2-2 moves in the second direction DR2, the connection plate CP connected to the (2-2)-th movement part MV2-2 may move in the second direction DR2.

Referring to FIGS. 4 and 7, the third rail part RAP3 may include a (3-1)-th rail RA3-1, a (3-1)-th movement part MV3-1, a third connection part CP3, a (3-2)-th rail RA3-2, and a (3-2)-th movement part MV3-2.

The (3-1)-th rail RA3-1 may be disposed on the rear surface RS of the first supporting plate SP1 to be connected to the first supporting plate SP1. The (3-1)-th rail RA3-1 may extend in the second direction DR2. The (3-1)-th movement part MV3-1 may be disposed on the (3-1)-th rail RA3-1, and coupled to the (3-1)-th rail RA3-1 to move along the (3-1)-th rail RA3-1. The (3-1)-th movement part MV3-1 may move in the second direction DR2 along the (3-1)-th rail RA3-1.

The third connection part CP3 may extend in the first direction DR1, and may be disposed on the (3-1)-th movement part MV3-1 to be connected to the (3-1)-th movement part MV3-1. The (3-2)-th rail RA3-2 may extend in the first direction DR1, and may be disposed on the third connection part CP3 to be connected to the third connection part CP3.

The (3-2)-th movement part MV3-2 may be disposed on the (3-2)-th rail RA3-2, and coupled to the (3-2)-th rail RA3-2 to move along the (3-2)-th rail RA3-2. The (3-2)-th movement part MV3-2 may move in the first direction DR1 along the (3-2)-th rail RA3-2. The connection plate CP illustrated in FIG. 5 may be disposed on the (3-2)-th movement part MV3-2 to be connected to the (3-2)-th movement part MV3-2.

When the (3-1)-th movement part MV3-1 moves in the second direction DR2, the third connection part CP3, the (3-2)-th rail RA3-2, and the (3-2)-th movement part MV3-2 may move in the second direction DR2 together with the (3-1)-th movement part MV3-1.

According to this configuration of the third rail part RAP3, the third rail part RAP3 may move in the first direction DRI and in the second direction DR2. Therefore, the connection plate CP connected to the third rail part RAP3 may also move in the first direction DR1 and in the second direction DR2.

In particular, when the (3-1)-th movement part MV3-1 moves in the second direction DR2, the third connection part CP3, the (3-2)-th rail RA3-2, and the (3-2)-th movement part MV3-2 may move in the second direction DR2 together with the (3-1)-th movement part MV3-1, so that the connection plate CP connected to the (3-2)-th movement part MV3-2 may also move in the second direction DR2. When the (3-2)-th movement part MV3-2 moves in the first direction DR1, the connection plate CP, connected to the (3-2)-th movement part MV3-2, may move in the first direction DR1.

Referring to FIGS. 4, 7, and 9, the fourth rail part RAP4 may be different from the third rail part RAP3 only partially in shape, but may have substantially the same configuration as that of the third rail part RAP3. The fourth rail part RAP4 may include a (4-1)-th rail RA4-1, a (4-1)-th movement part MV4-1, a fourth connection part CP4, a (4-2)-th rail RA4-2, and a (4-2)-th movement part MV4-2.

The (4-1)-th rail RA4-1 may be disposed on the rear surface RS of the first supporting plate SP1 to be connected to the first supporting plate SP1. The (4-1)-th rail RA4-1 may extend in the second direction DR2. The (4-1)-th movement part MV4-1 may be disposed on the (4-1)-th rail RA4-1, and coupled to the (4-1)-th rail RA4-1 to move along the (4-1)-th rail RA4-1. The (4-1)-th movement part MV4-1 may move in the second direction DR2 along the (4-1)-th rail RA4-1.

The fourth connection part CP4 may extend in the first direction DR1, and may be disposed on the (4-1)-th movement part MV4-1 to be connected to the (4-1)-th movement part MV4-1. The (4-2)-th rail RA4-2 may extend in the first direction DR1, and may be disposed on the fourth connection part CP4 to be connected to the fourth connection part CP4.

When viewed on a plane, a second hole H2 extending in the second direction DR2 may be defined in a portion of the fourth connection part CP4 that does not overlap the (4-1)-th movement part MV4-1. A second drive bar DB2 illustrated in FIG. 7 may be connected to the second drive part DV2. The second drive bar DB2 may extend in the second direction DR2 to be disposed in the second hole H2 illustrated in FIG. 9. To clearly illustrate the second hole H2, the second drive bar DB2 is omitted in FIG. 9.

The (4-2)-th movement part MV4-2 may be disposed on the (4-2)-th rail RA4-2, and coupled to the (4-2)-th rail RA4-2 to move along the (4-2)-th rail RA4-2. The (4-2)-th movement part MV4-2 may move in the first direction DR1 along the (4-2)-th rail RA4-2. The connection plate CP illustrated in FIG. 5 may be disposed on the (4-2)-th movement part MV4-2 to be connected to the (4-2)-th movement part MV4-2.

When the (4-1)-th movement part MV4-1 moves in the second direction DR2, the fourth connection part CP4, the (4-2)-th rail RA4-2, and the (4-2)-th movement part MV4-2 may move in the second direction DR2 together with the (4-1)-th movement part MV4-1.

According to this configuration of the fourth rail part RAP4, the fourth rail part RAP4 may move in the first direction DR1 and in the second direction DR2. Therefore, the connection plate CP connected to the fourth rail part RAP4 may also move in the first direction DR1 and in the second direction DR2.

In particular, when the (4-1)-th movement part MV4-1 moves in the second direction DR2, the fourth connection part CP4, the (4-2)-th rail RA4-2, and the (4-2)-th movement part MV4-2 may move in the second direction DR2 together with the (4-1)-th movement part MV4-1, so that the connection plate CP connected to the (4-2)-th movement part MV4-2 may also move in the second direction DR2. When the (4-2)-th movement part MV4-2 moves in the first direction DR1, the connection plate CP connected to the (4-2)-th movement part MV4-2 may move in the first direction DR1.

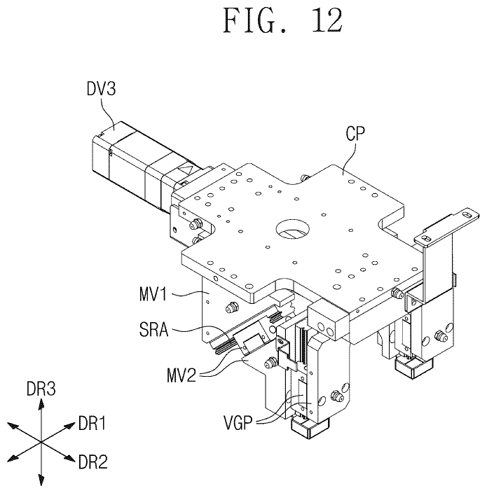

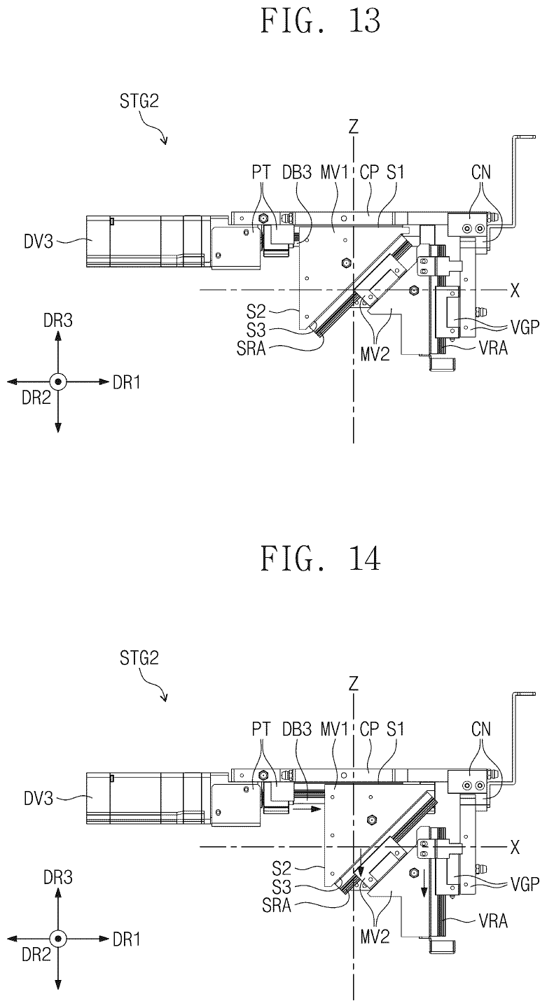

FIG. 10 is a perspective view of the rear of the second rail part illustrated in FIG. 8. FIG. 11 is a perspective view of the rear of the fourth rail part illustrated in FIG. 9.

FIGS. 10 and 11 exemplarily illustrate the first drive bar DB1 and the second drive bar DB2 together with the second rail part RAP2 and the fourth rail part RAP4.

Referring to FIGS. 7, 8, and 10, a first drive bar connection part DCP1 may be disposed on a rear surface of the second connection part CP2, and the first drive bar connection part DCP1 may be connected to the rear surface of the second connection part CP2. The first drive bar DB1 may be disposed in the first hole H1, and may pass through the first drive bar connection part DCP1.

The first drive bar DB1 may be connected to the first drive bar connection part DCP1. The first drive bar DB1 may be connected to the second rail part RAP2 through the first drive bar connection part DCP1. The first drive part DV1 may be connected to the second rail part RAP2 through the first drive bar DB1.

Referring to FIGS. 7, 9, and 11, a second drive bar connection part DCP2 may be disposed on a rear surface of the fourth connection part CP4, and the second drive bar connection part DCP2 may be connected to the rear surface of the fourth connection part CP4. The second drive bar DB2 may be disposed in the second hole H2, and may pass through the second drive bar connection part DCP2.

The second drive bar DB2 may be connected to the second drive bar connection part DCP2. Therefore, the second drive bar DB2 may be connected to the fourth rail part RAP4 through the second drive bar connection part DCP2. The second drive part DV2 may be connected to the fourth rail part RAP4 through the second drive bar DB2.

Referring to FIGS. 7 to 11, the first drive part DV1 may move the first drive bar DB1 in the first direction DR1. When the first drive bar DB1 moves in the first direction DR1, the second rail part RAP2, connected to the first drive bar DB1, may move in the first direction DR1. Therefore, the connection plate CP connected to the second rail part RAP2 may move in the first direction DR1.

For example, when the first drive bar DB1 moves in the first direction DR1, the (2-1)-th movement part MV2-1 may move in the first direction DR1. Therefore, the connection plate CP connected to the (2-2)-th movement part MV2-2 may also move in the first direction DR1.

When the connection plate CP moves in the first direction DR1, the first, third, and fourth rail parts RAP1, RAP3, and RAP4, connected to the connection plate CP, may also move in the first direction DR1. For example, the (1-1)-th movement part MV1-1, the (3-2)-th movement part MV3-2, and the (4-2)-th movement part MV4-2 may move in the first direction DR1. Therefore, the first drive part DV1 may move the connection plate CP in the first direction DR1.

The second drive part DV2 may move the second drive bar DB2 in the second direction DR2. When the second drive bar DB2 moves in the second direction DR2, the fourth rail part RAP4, connected to the second drive bar DB2, may move in the second direction DR2. Therefore, the connection plate CP connected to the fourth rail part RAP4 may move in the second direction DR2.

For example, when the second drive bar DB2 moves in the second direction DR2, the (4-1)-th movement part MV4-1 may move in the second direction DR2. Therefore, the connection plate CP connected to the (4-2)-th movement part MV4-2 may also move in the second direction DR2.

When the connection plate CP moves in the second direction DR2, the first, second, and third rail parts RAP1, RAP2, and RAP3, connected to the connection plate CP, may also move in the second direction DR2. For example, the (1-2)-th movement part MV1-2, the (2-2)-th movement part MV2-2, and the (3-1)-th movement part MV3-1 may move in the second direction DR2. Therefore, the second drive part DV2 may move the connection plate CP in the second direction DR2.

The first and second drive parts DV1 and DV2, the first to fourth rail parts RAP1 to RAP4, the first and second drive bars DB1 and DB2, and the connection plate CP, illustrated in FIGS. 4 to 11, may be defined as a first stage STG1. That is, the first stage STG1 may include the first and second drive parts DV1 and DV2, the first to fourth rail parts RAP1 to RAP4, the first and second drive bars DB1 and DB2, and the connection plate CP.

For convenience, the reference symbol of the first stage STG1 is illustrated only in FIG. 4 among FIGS. 4 to 7. The first stage STG1 may be defined as a UVW stage.

FIG. 12 is a perspective view of the connection plate CP, the third drive part DV3, the first and second movement parts MV1, MV2, and the vertical guide part VGP illustrated in FIGS. 1 to 3. FIG. 13 is a side view of the connection plate CP, the third drive part DV3, first and second movement parts MV1, MV2, and a vertical guide part VGP of the structure illustrated in FIG. 12, viewed from a second direction.

FIGS. 12 and 13 exemplarily illustrate that the connection plate CP, the third drive part DV3, the first and second movement parts MV1 and MV2, and the vertical guide part VGP are coupled to each other.

Referring to FIGS. 12 and 13, the third drive part DV3 may extend in a first direction DR1. The first and second movement parts MV1 and MV2 may be spaced apart from the third drive part DV3 in the first direction DR1.

The third drive part DV3 may be connected to a lower surface of the connection plate CP. In particular, a portion PT of the third drive part DV3, adjacent to one side of the third drive part DV3 facing toward the first movement part MV1, may be disposed under the connection plate CP to be connected to the lower surface of the connection plate CP.

The first movement part MV1 may be connected to the third drive part DV3 in the first direction DR1, and may thus move in the first direction DR1. For example, a third drive bar DB3 may be disposed between the third drive part DV3 and the first movement part MV1, and may be connected to the third drive part DV3 and the first movement part MV1. Although not illustrated in the drawing, the third drive bar DB3 may extend into the third drive part DV3 and be connected to a motor inside the third drive part DV3. The third drive bar DB3 may extend from the third drive part DV3 in the first direction DR1, and may thus be connected to the first movement part MV1.

The third drive part DV3 may move the first movement part MV1 in the first direction DR1. For example, as the third drive part DV3 moves the third drive bar DB3 in the first direction DR1, the first movement part MV1 may also move in the first direction DR1.

The first movement part MV1 may be schematically triangular in shape, as shown in FIG. 13. Among a first side S1 and a second side S2 at right angles to each other, the first side S1 may face the connection plate CP, and the second side S2 may be disposed toward the third drive part DV3. A third side S3, defined as a slope, may be disposed facing downwards.

The second movement part MV2 may be disposed adjacent to the third side S3, and may be connected to the first movement part MV1 to move along the third side S3. For example, a slope rail SRA may be disposed on the third side S3. The slope rail SRA may be connected to the third side S3. The second movement part MV2 may be coupled to the slope rail SRA to move along a sloping direction of the slope rail SRA.

A portion of the second movement part MV2 connected to the slope rail SRA may be defined as one side of the second movement part MV2. The other side of the second movement part MV2, opposed to the one side of the second movement part MV2, may be coupled to the vertical guide part VGP to move in a third direction DR3.

For example, a vertical rail VRA, extending in the third direction DR3, may be connected to the other side of the second movement part MV2. The vertical rail VRA may be coupled to the vertical guide part VGP. The second movement part MV2 may be coupled to move in the third direction DR3 with respect to the vertical guide part VGP through the vertical rail VRA.

The vertical guide part VGP may be connected to the connection plate CP. For example, a connection part CN may be connected to the other side of the connection plate CP opposed to one side of the connection plate CP connected to the third drive part DV3. The vertical guide part VGP may be connected to the connection plate CP through the connection part CN. The vertical guide part VGP may be connected to the connection part CN and extend downwards.

The third drive part DV3, the third drive bar DB3, the first and second movement parts MV1 and MV2, the slope rail SRA, the vertical rail VRA, and the vertical guide part VGP may be defined as a second stage STG2. That is, the second stage STG2 may include the third drive part DV3, the third drive bar DB3, the first and second movement parts MV1 and MV2, the slope rail SRA, the vertical rail VRA, and the vertical guide part VGP. The second stage STG2 may be defined as a Z wedge stage.

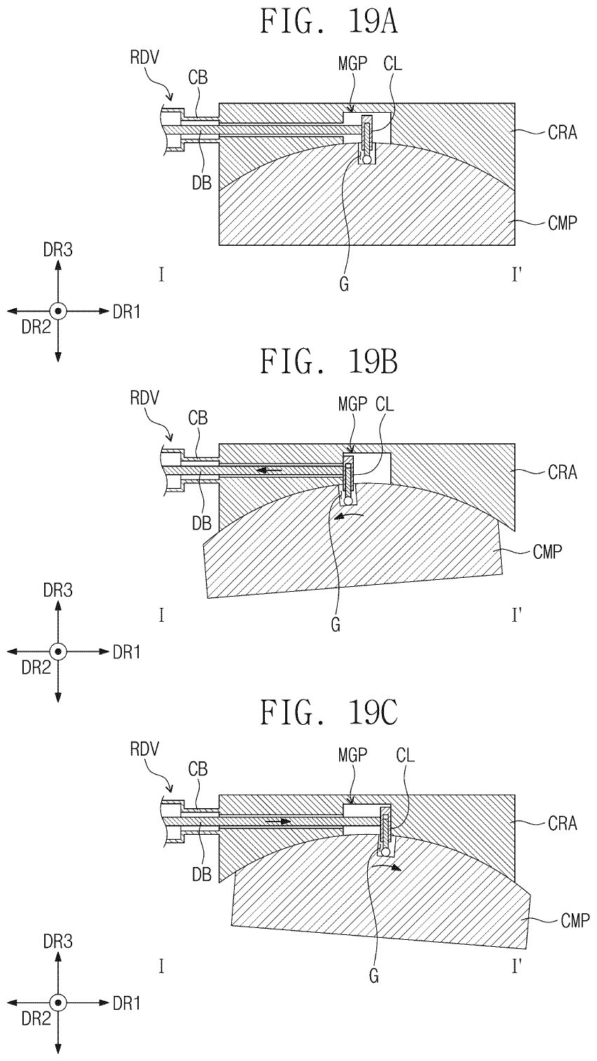

FIG. 14 is a drawing illustrating a movement state of the first movement part and the second movement part illustrated in FIG. 13.

Referring to FIGS. 13 and 14, an x-axis X, parallel to a first direction DR1, and a z-axis Z, parallel to a third direction DR3, may be defined. The third drive part DV3 may move the third drive bar DB3 in the first direction DR1, and may thus move the first movement part MV1 in the first direction DR1. Therefore, the x-axis X coordinate of the first movement part MV1 may be changed.

When the first movement part MV1 moves in the first direction DR1, the x-axis X coordinates of the third drive part DV3 and the vertical guide part VGP, connected to the connection plate CP, may be fixed. In addition, the x-axis X coordinate of the second movement part MV2, connected to the vertical guide part VGP, may also be fixed.

When the first movement part MV1 moves in the first direction DR1, the second movement part MV2 may move downwards along the slope rail SRA. In addition, the vertical rail VRA, connected to the second movement part MV2, may move downwards along the vertical guide part VGP. That is, the second movement part MV2 may move downward along the vertical guide part VGP. Therefore, the z-axis Z coordinate of the second movement part MV2 may be changed.

The second movement part MV2 may move along the slope rail SRA, and substantially move in the third direction DR3. Therefore, the second movement part MV2 may be coupled to move in the third direction DR3 with respect to the first movement part MV1.

As illustrated in FIG. 14, when the first movement part MV1 moves to the right of the first direction DR1, the second movement part MV2 may move downward. When the first movement part MV1 moves to the left of the first direction DR1, from a state in FIG. 14 to a state in FIG. 13, the second movement part MV2 may move upward.

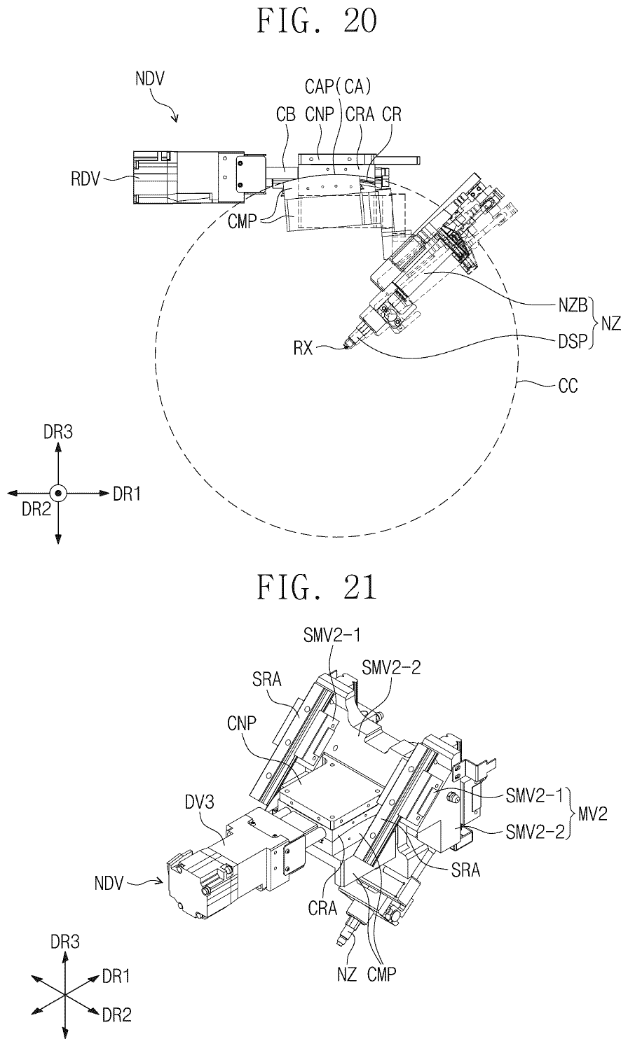

FIG. 15 is a drawing illustrating a connection state of the first stage, illustrated in FIG. 4, and the second stage illustrated in FIG. 13.

In FIG. 15, the first stage STG1 is illustrated in a normal arrangement state by inverting the first stage STG1 illustrated in FIG. 4. FIG. 15 exemplarily illustrates a side view when viewed from a second direction DR2.

Referring to FIG. 15, the second stage STG2 may be connected to the connection plate CP. The second stage STG2 may be connected to the first stage STG1 through the connection plate CP.

As previously described, the first drive part DV1 may move the connection plate CP in a first direction DR1, and the second drive part DV2 may move the connection plate CP in the second direction DR2. The first drive part DV1 may move the second stage STG2, connected to the connection plate CP, in the first direction DR1, and the second drive part DV2 may move the second stage STG2, connected to the connection plate CP, in the second direction DR2.

Therefore, the first drive part DV1 may move the third drive part DV3, the first and second movement parts MV1 and MV2, and the vertical guide part VGP in the first direction DR1. In addition, the third drive part DV3, the first and second movement parts MV1 and MV2, and the vertical guide part VGP may be moved in the second direction DR2 by the second drive part DV2.

FIG. 16 is a perspective view of the rotation drive part RDV, the curved rail part CRA, the curved movement part CMP, and the nozzle NZ illustrated in FIGS. 1 to 3. FIG. 17 is a side view of the rotation drive part RDV, the curved rail part CRA, the curved movement part CMP, and the nozzle NZ of FIG. 16 as viewed from a second direction. FIG. 18 illustrates a movement state of the curved movement part CMP with respect to the curved rail part CRA.

FIG. 16 exemplarily illustrates that the rotation drive part RDV, the curved rail part CRA, the curved movement part CMP, and the nozzle NZ are coupled to each other.

Referring to FIGS. 16 and 17, the curved rail part CRA may be connected to the rotation drive part RDV in a first direction DR1. For example, a plurality of connecting bars CB extending in the first direction DR1 may be disposed between the rotation drive part RDA and the curved rail part CRA to connect the rotation drive part RDV to the curved rail part CRA.

The curved movement part CMP may be coupled to a lower portion of the curved rail part CRA to move with respect to the curved rail part CRA. An upper end of the curved movement part CMP may be defined as a curve portion CAP having a predetermined arc CA. A contact surface (not shown) of the curved rail part CRA, which is in contact with the upper end of the curved movement part CMP, may also have a curve shape corresponding to the curve portion CAP.

The nozzle NZ may be connected to the curved movement part CMP. The nozzle NZ may be connected to the other side of the curved movement part CMP opposed to the side of the curved movement part CMP that is adjacent to the rotation drive part RDV. The nozzle NZ may be connected to the curved movement part CMP through a nozzle connection part NCP.

The nozzle connection part NCP may include a first nozzle connection part NCP1 connected to the curved movement part CMP, and a second nozzle connection part NCP2 connected to the first nozzle connection part NCP1 and the nozzle NZ. The first nozzle connection part NCP1 may be connected to the other side of the curved movement part CMP to extend downward. The second nozzle connection part NCP2 may be connected to a lower end of the first nozzle connection part NCP1 and the nozzle NZ.

The nozzle NZ may include a nozzle body NZB and a discharge part DSP connected to a lower end of the nozzle body NZB. Although not illustrated in the drawing, a nozzle supply pipe may be disposed in the nozzle body NZB, and the nozzle supply pipe may be connected to the discharge part DSP. The nozzle NZ may discharge a resin having black color. The resin may be discharged through the discharge part DSP.

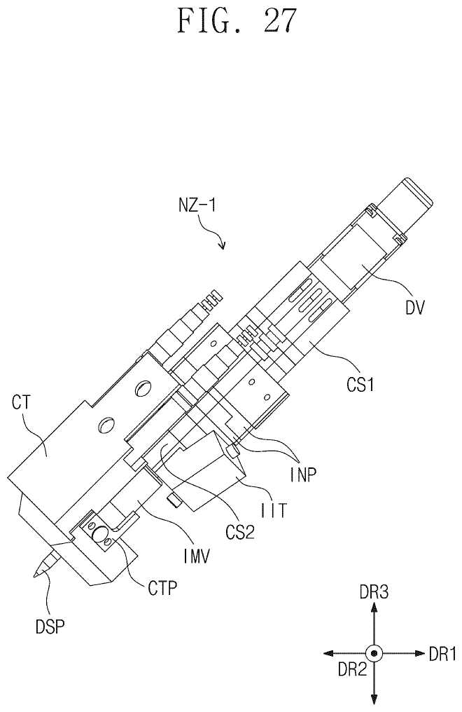

A connection part CNP may be disposed on the curved rail part CRA. The curved rail part CRA may be disposed under and connected to the connection part CNP. The connection part CNP may be connected to the second movement part MV2 previously described. More details regarding this configuration will be described below in reference to FIG. 21.

Referring to FIGS. 17 and 18, when viewed from the second direction DR2, the curved movement part CMP may move in a curve direction, defined by the predetermined arc CA, with respect to the curved rail part CRA. Substantially, the curve portion CAP may slide in the curve direction with respect to the contact surface of the curved rail part CRA which is in contact with the curve portion CAP, so that the curved movement part CMP may be moved.

The curved movement part CMP may include a curved rail CR. For example, a lower portion of the curved rail part CRA may be formed of the curved rail CR. FIG. 18 exemplarily illustrates the curved rail CR, which is blocked by the curved movement part CMP, in a dotted line. When viewed from the second direction DR2, the curved rail CR may have a curve shape parallel to the curve portion CAP. That is, the curved rail CR, like the curve portion CAP, may also have a curve shape corresponding to the arc CA.

The curved movement part CMP may be coupled to the curved rail CR to move along the curved rail CR. That is, the curved movement part CMP may move in the curve direction corresponding to the arc CA.

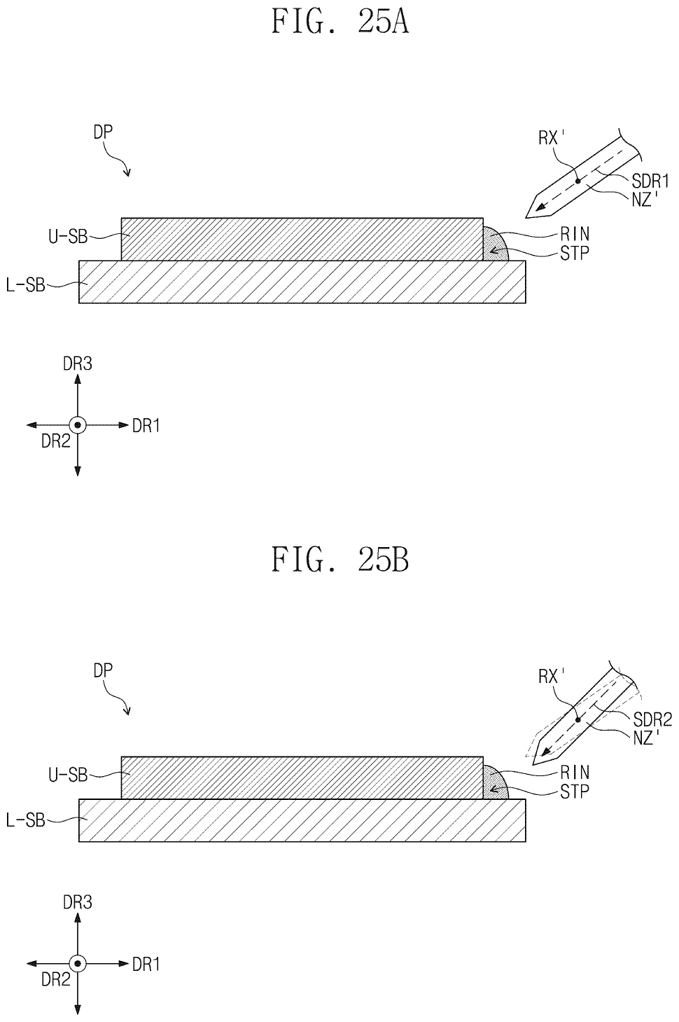

FIG. 19A is a cross-sectional view taken along line I-I′ of FIG. 16. FIGS. 19B and 19C are drawings illustrating a movement state of a curved movement part with respect to a curved rail part.

FIGS. 19A to 19C exemplarily illustrate a cross-section of the curved rail part CRA and the curved movement part CMP, and the connection part CNP is omitted.

Referring to FIG. 19A, a drive bar DB may be disposed inside the rotation drive part RDV. The drive bar DB may extend from the rotation drive part RDV in a first direction DR1 to be disposed in an inner space of the connecting bar CB. The drive bar DB may extend toward the inside of the curved rail part CRA in the first direction DR1 to be disposed inside the curved rail part CRA. A movement guide groove MGP, having a predetermined width in the first direction DR1, may be defined inside the curved rail part CRA.

The drive bar DB may be connected to the curved movement part CMP. For example, a coupling part CL may be connected to an end of the drive bar DB inside the curved rail part CRA. The coupling part CL may extend in a third direction DR3 to be coupled to the curved movement part CMP. A lower end of the coupling part CL may be disposed in a groove G, defined on an upper surface of the curved movement part CMP, to be rotatably coupled to the rotation movement part CMP.

When the drive bar DB moves in the first direction DR1, the coupling part CL may move in the first direction DR1 along the movement guide groove MGP. Movement of the coupling part CL may be limited by the width of the movement guide groove MGP in the first direction DR1.

Referring to FIGS. 19A and 19B, the drive bar DB may move to the left in the first direction DR1. The coupling part CL, which is attached to the drive bar DB, may also move to the left. The curved movement part CMP, which is moved by the coupling part CL, may move to the left in a curve direction corresponding to an arc CA.

The coupling part CL may extend and shrink in a third direction DR3 as the curved movement part CMP moves, to maintain secure connection to the curved movement part CMP as the curved movement part CMP moves in an arc. When the curved movement part CMP, connected to the coupling part CL, moves to the left, the coupling part CL may extend in the third direction DR3 due to the change in distance between the drive bar DB and the point of contact where the tip of coupling part CL meets the curved movement part CMP. When the coupling part CL moves from a state illustrated in FIG. 19B to a state illustrated in FIG. 19A, the coupling part CL may shrink in the third direction DR3.

The state illustrated in FIG. 19A may substantially correspond to a state illustrated in FIG. 17. The state illustrated in FIG. 19B may substantially correspond to a state illustrated in FIG. 18.

Referring to FIGS. 19A and 19C, the drive bar DB may move to the right in the first direction DR1. The coupling part CL, which is attached to the drive bar DB, may also move to the right. The curved movement part CMP, connected to the coupling part CL, may move to the right in the curve direction corresponding to the arc CA. When the curved movement part CMP, connected to the coupling part CL, moves to the right, the coupling part CL may extend in the third direction DR3.

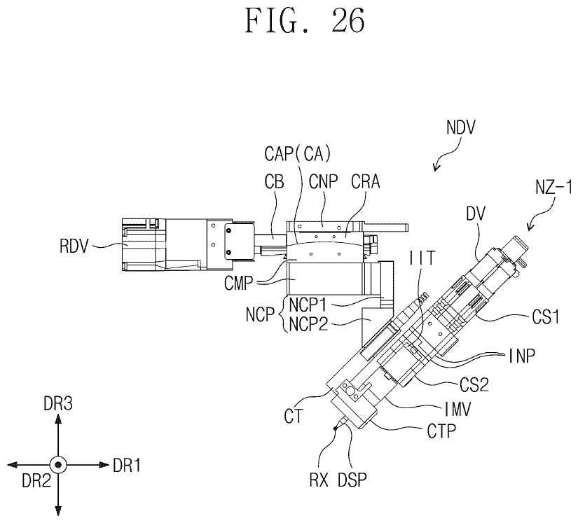

FIG. 20 is a drawing illustrating the movement of the nozzle illustrated in FIGS. 17 and 18.

FIG. 20 exemplarily illustrates the state of the nozzle illustrated in FIG. 17 in a dotted line.

FIG. 20 shows a circle CC, part of which is the arc CA of the curve portion CAP. The center of the circle CC may coincide with a tip of the nozzle NZ. A rotation axis RX extends through the center of the circle CC and extends in a second direction DR2. The rotation axis RX may coincide with the tip of the nozzle NZ. In particular, the rotation axis RX may coincide with a tip of the discharge part DSP.

The nozzle drive part NDV may move the nozzle NZ to pivot around the rotation axis RX. In particular, when the curved movement part CMP moves in a curve direction, the nozzle NZ may rotate about the rotation axis RX by the curved movement part CMP. That is, the nozzle NZ may pivot around the tip of the nozzle NZ (for example, the tip of the discharge part DSP) that discharges the resin such that the position of the tip of the nozzle NZ is unchanged. For example, the rotation angle of the nozzle NZ with respect to the first direction DR1 may be set to about 30° to about 45°.

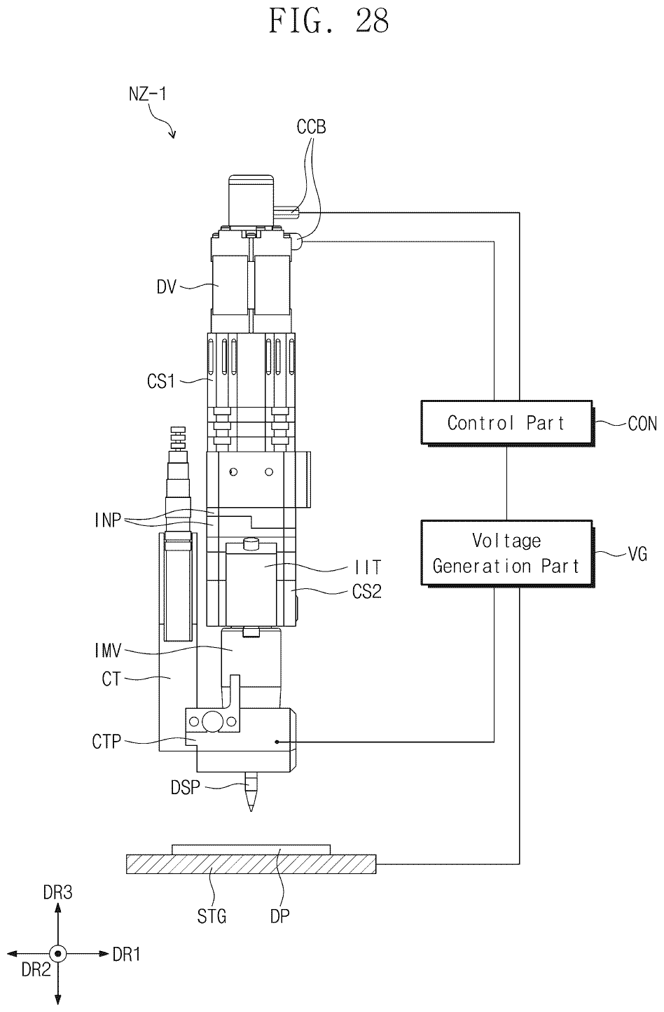

FIG. 21 is a drawing illustrating a connection state of the nozzle drive part, illustrated in FIG. 17, and the second movement part illustrated in FIG. 13. FIG. 22 is a drawing illustrating a connection state of the nozzle drive part, illustrated in FIG. 17, and a second stage illustrated in FIG. 13.

FIG. 21 exemplarily illustrates a perspective view, and FIG. 22 exemplarily illustrates a side view when viewed from a second direction DR2. For the convenience of description, the first movement part MV1 is omitted in FIG. 21.

Referring to FIG. 21, the slope rail SRA may be provided substantially in a pair. The pair of the slope rails SRA may be spaced apart from each other in the second direction DR2.

The second movement part MV2 may include a pair of (2-1)-th sub movement parts SMV2-1 and a (2-2)-th sub movement part SMV2-2. The (2-1)-th sub movement parts SMV2-1 may be respectively coupled to the slope rails SRA under the slope rails SRA. The (2-1)-th sub movement parts SMV2-1 may be disposed on the (2-2)-th sub movement part SMV2-2, and connected to the (2-2)-th sub movement part SMV2-2.

The connection part CNP may be disposed between the slope rails SRA. The connection part CNP may be disposed between two (2-1)-th sub movement parts SMV2-1, and be connected to the (2-2)-th sub movement part SMV2-2. Therefore, the connection part CNP may be connected to the second movement part MV2.

The third drive part DV3, the curved rail part CRA, and the curved movement part CMP may be connected to the (2-2)-th sub movement part SMV2-2 through the connection part CNP. Therefore, the nozzle drive part NDV may be connected to the second movement part MV2 through the connection part CNP.

Referring to FIGS. 21 and 22, the nozzle drive part NDV may be connected to the second stage STG2 through the connection part CNP. As previously described, the second movement part MV2 may be moved in a third direction DR3 by the third drive part DV3. When the second movement part MV2 is moved in the third direction DR3 by the third drive part DV3, the nozzle drive part NDV connected to the second movement part MV2 may also move in the third direction DR3. In addition, the nozzle NZ connected to the nozzle drive part NDV may also move in the third direction DR3.

According to the operation of the third drive part DV3 that moves the second movement part MV2, the nozzle drive part NDV and the nozzle NZ may move in the third direction DR3. Therefore, the rotation drive part RDV, the curved rail part CRA, the curved movement part CMP, and the nozzle NZ may be moved in the third direction DR3 substantially by the third drive part DV3.

As previously described, the first drive part DV1 and the second drive part DV2 may move the second stage STG2 in the first direction DR1 and in the second direction DR2. The nozzle drive part NDV may be connected to the second stage STG2. Therefore, the rotation drive part RDV, the curved rail part CRA, the curved movement part CMP, and the nozzle NZ may also be moved in the first direction DR1 and in the second direction DR2 by the first drive part DV1 and the second drive part DV2.

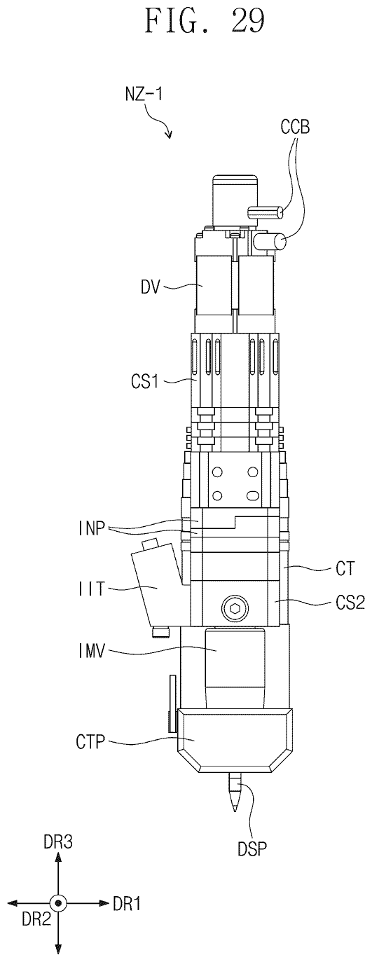

FIG. 23 is a drawing schematically illustrating a cross-section of a display panel manufactured by the dispensing device illustrated in FIGS. 1 to 3.

FIG. 23 exemplarily illustrates the cross-section of the display panel DP when viewed from a second direction DR2.

Referring to FIG. 23, the display panel DP according to an embodiment of the inventive concept may be an emission-type display panel, and is not particularly limited thereto. For example, the display panel DP may be an organic light-emitting display panel or a quantum-dot light-emitting display panel. A light-emitting layer of the organic light-emitting display panel may include an organic light-emitting material. A light-emitting layer of the quantum-dot light-emitting display panel may include quantum dots, quantum rods, and the like. Hereinafter, the display panel DP is described as the organic light-emitting display panel.

The display panel DP may include a lower substrate L-SB, an upper substrate U-SB disposed on the lower substrate L-SB, and a light-blocking layer LSL disposed on surfaces near where the lower substrate L-SB meets the upper substrate U-SB.

The upper substrate U-SB may include a light-emitting element layer OL, an encapsulation substrate EN-SB, a sealing layer SAL, and a filler FL. The light-emitting element layer OL may be disposed on the lower substrate L-SB. The light-emitting element layer OL may include a plurality of light-emitting elements. Although not illustrated in the drawing, the lower substrate L-SB may include a plurality of transistors connected to the light-emitting elements.

The lower substrate L-SB may include a display region DA and a non-display region NDA around the display region DA. The light-emitting element layer OL may be disposed in the display region DA.

The encapsulation substrate EN-SB may be disposed on the light-emitting element layer OL. The sealing layer SAL may be disposed between the lower substrate L-SB and the encapsulation substrate EN-SB. The sealing layer SAL may be disposed in the non-display region NDA. The sealing layer SAL may join the lower substrate L-SB and the encapsulation substrate EN-SB together. The light-emitting element layer OL may be sealed between the lower substrate L-SB and the encapsulation substrate EN-SB by the sealing layer SAL.

The filler FL may be disposed between the lower substrate L-SB and the encapsulation substrate EN-SB. The filler FL may be disposed in a space sealed by the sealing layer SAL between the lower substrate L-SB and the encapsulation substrate EN-SB.

The upper substrate U-SB may have a smaller width than that of the lower substrate L-SB. The width may be defined as a numerical value measured in the first direction DR1 or in the second direction DR2. The width of the upper substrate U-SB and the width of the lower substrate L-SB are different from each other, and thus the edge of the lower substrate L-SB and the edge of the upper substrate U-SB may form a step.

An edge of the display panel DP may be defined as a step portion STP between the edge of the lower substrate L-SB and the edge of the upper substrate U-SB. The light-blocking layer LSL may be disposed in the step portion STP. The light-blocking layer LSL may have black color for blocking light.

Light generated in the light-emitting element layer OL may leak to the outside through the step portion STP. This phenomenon is sometimes referred to as “light leakage phenomenon.” The light-blocking layer LSL may block the light generated in the light-emitting element layer OL from leaking through the step portion STP. That is, the light-blocking layer LSL may be used to prevent the light leakage phenomenon. The light-blocking layer LSL may be provided onto the step portion STP by the dispensing device DPA illustrated in FIGS. 1 to 3.

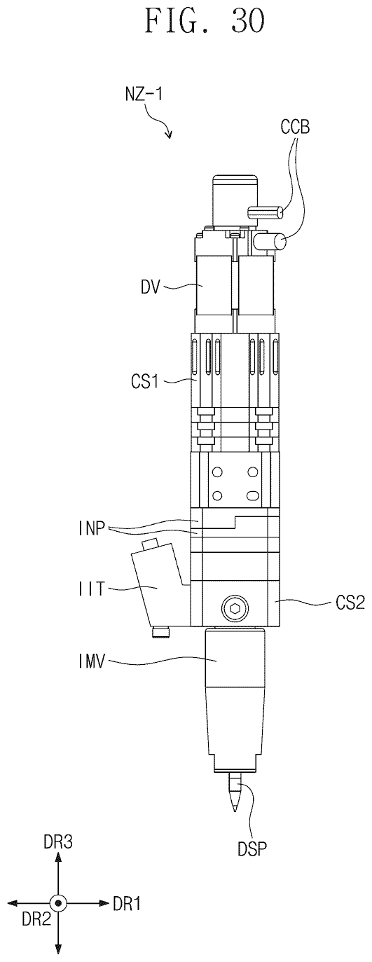

FIGS. 24A to 24C are drawings illustrating a method of forming a light-blocking layer using a dispensing device according to an embodiment of the inventive concept.

FIGS. 24A to 24C exemplarily illustrate that a nozzle NZ is simplified, unlike in the previous drawings.

Referring to FIG. 24A, the nozzle NZ may be disposed adjacent to a side surface of a display panel DP that extends in a second direction DR2. After this, an aligning process of the nozzle NZ may be performed such that the nozzle NZ heads to a step portion STP.

The nozzle NZ may be aligned according to the operations of the first to third drive parts DV1, DV2, and DV3 previously described. For example, when the nozzle NZ is disposed toward the side surface of the display panel DP parallel to the second direction DR2, the nozzle NZ may be moved in a first direction DR1 by the first drive part DV1, and the nozzle NZ may be moved in a third direction DR3 by the third drive part DV3. According to these operations, the nozzle NZ may be disposed toward the step portion STP. The nozzle NZ may discharge a resin RIN toward the step portion STP.

Referring to FIGS. 24A and 24B, the resin RIN may be provided to various target points (not shown) of the step portion STP. The nozzle NZ may discharge the resin RIN multiple times toward the various target points of the step portion STP.

For example, as illustrated in FIG. 24A, the nozzle NZ may be disposed in a first slope direction SDR1, defined by a predetermined angle with respect to a top surface of the lower substrate L-SB, so that the resin RIN may be provided to the step portion STP. After this, the nozzle NZ may rotate with respect to the tip of the nozzle NZ through the nozzle drive part NDV previously described, and may thus be disposed in a second slope direction SDR2 different from the first slope direction SDR1. Therefore, the nozzle NZ may be disposed in the second slope direction SDR2, as illustrated in FIG. 24B, so that the resin RIN may be provided to the step portion STP.

Referring to FIG. 24C, the nozzle NZ may be disposed adjacent to a side surface of the display panel DP that extends in the first direction DR1. In this case, the nozzle NZ may be moved in the second direction DR2 by the second drive part DV2, and the nozzle NZ may be moved in the third direction DR3 by the third drive part DV3. According to these operations, the nozzle NZ may point toward the step portion STP. After this, a resin-discharging process, similar with the process described with reference to FIGS. 24A and 24B, may be performed.

Although not illustrated in the drawing, the nozzle NZ may be changed from a state where the nozzle NZ is disposed adjacent to the side surface of the display panel DP that extends in the second direction DR2, as illustrated in FIG. 24A, to a state where the nozzle NZ is disposed adjacent to the side surface of the display panel DP that extends in the first direction DR1 as illustrated in FIG. 24C. In this case, the nozzle NZ may rotate about 90° about a rotation axis parallel to the third direction DR3, and this operation may be performed according to a rotation operation of the rotation head RH which rotates with respect to the head rotation axis HRX, previously described.

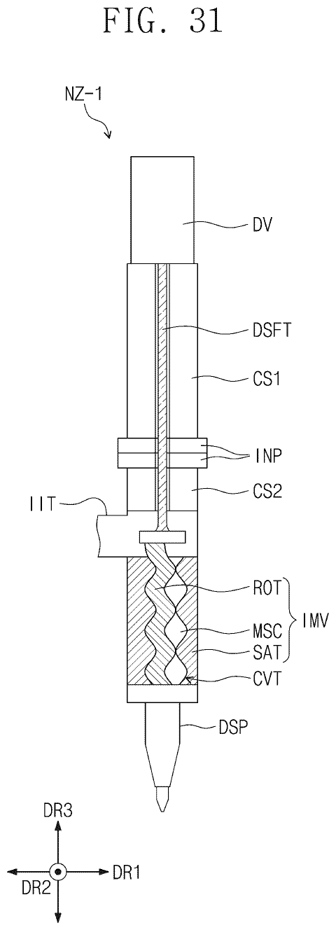

FIGS. 25A and 25B are drawings illustrating a method of forming a light-blocking layer using a nozzle of a dispensing device according to Comparative Example.

Referring to FIG. 25A, a resin may be provided to a step portion STP by a nozzle NZ′ disposed in a first slope direction SDR1.

Referring to FIG. 25B, the nozzle NZ′ may rotate about a rotation axis RX′ that coincides with the center portion of the nozzle NZ′, not the tip of the nozzle NZ′. When the nozzle NZ′ rotates about the rotation axis RX′ in order to change the direction of the nozzle NZ′ to a second slope direction SDR2, the position of the tip of the nozzle NZ′ that discharges the resin RIN may change. Therefore, an additional process may need to be performed in order to align the position of the lower end of the nozzle NZ′ back to the original state illustrated in FIG. 25A.

However, according to an embodiment of the inventive concept, a nozzle drive part NDV may rotate a nozzle NZ with respect to a lower end of the nozzle NZ that discharges a resin RIN, thereby aligning the nozzle. Therefore, an aligning operation of the nozzle NZ may be performed more easily.

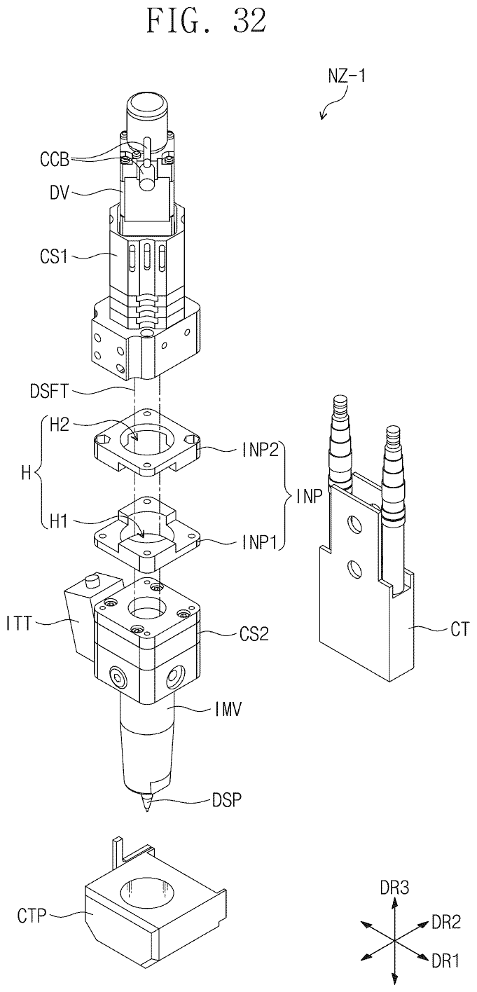

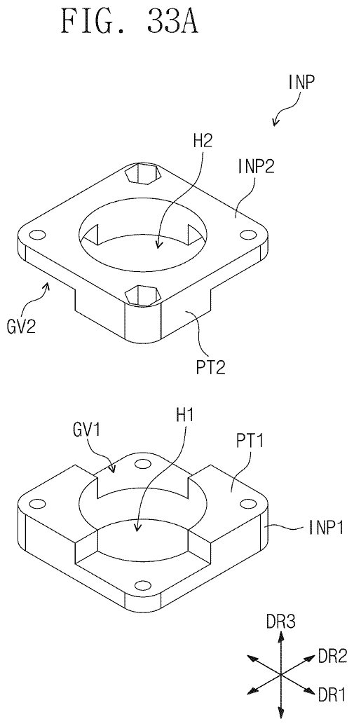

FIG. 26 is a drawing of a nozzle according to another embodiment of the inventive concept. FIG. 27 is a perspective view of the nozzle illustrated in FIG. 26.

FIG. 26 is exemplarily illustrated as a side view corresponding to FIG. 17. Hereinafter, FIGS. 26 to 31 illustrate that first, second, and third directions DR1, DR2, and DR3 are fixed and the position of a discharge device NZ-1 is variously changed.

Referring to FIGS. 26 and 27, the previously-described dispensing device DPA may include a nozzle NZ-1 illustrated in FIG. 26. The nozzle NZ-1 may be connected to a curved movement part CMP through a nozzle connection part NCP. The nozzle NZ-1 may be defined as a discharge device. Hereinafter, the nozzle NZ-1 is referred to as the discharge device.

The discharge device NZ-1 may be connected to a second nozzle connection part NCP2. The discharge device NZ-1, like the nozzle NZ previously described, may be disposed to be inclined toward the first direction DR1, and may rotate with respect to a tip of the discharge device NZ-1. According to operation of the curved movement part CMP previously described, the discharge device NZ-1 may rotate with respect to the tip of the discharge device NZ-1.

The discharge device NZ-1 may include a drive part DV, a first case CS1, a second case CS2, an insulation part INP, an ink inlet pipe IIT, an ink transfer part IMV, a conductive part CTP, a connecting part CT, and a discharge part DSP.

The first case CS1 may be disposed under the drive part DV, the insulation part INP may be disposed under the first case CS1, and the second case CS2 may be disposed under the insulation part INP. The ink inlet pipe IIT may be disposed on a side surface of the second case CS2, the ink transfer part IMV may be disposed under the second case CS2, and the discharge part DSP may be disposed under the ink transfer part IMV.

The conductive part CTP may be connected to the ink transfer part IMV, and may be disposed to be adjacent to the discharge part DSP. The connecting part CT may be connected to one end of the conductive part CTP, and disposed on the ink transfer part IMV and the second case CS2. The connecting part CT may be connected to the second nozzle connection part NCP2. Accordingly, the discharge device NZ-1 may be connected to the curved movement part CMP through the connecting part CT and the nozzle connection part NCP.

As previously described, a rotation axis RX may coincide with a tip of the discharge part DSP. According to operation of the curved movement part CMP, the discharge device NZ-1 may rotate with respect to the lower end of the discharge part DSP.

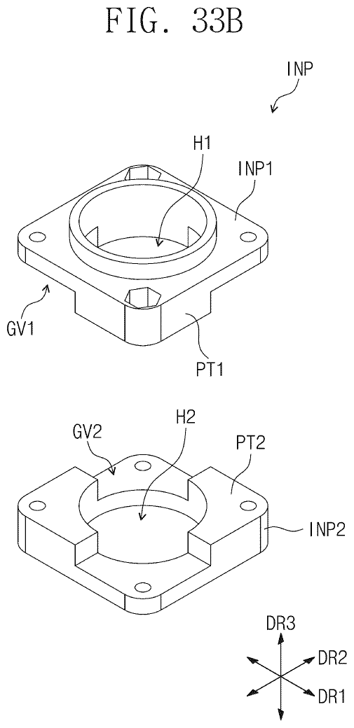

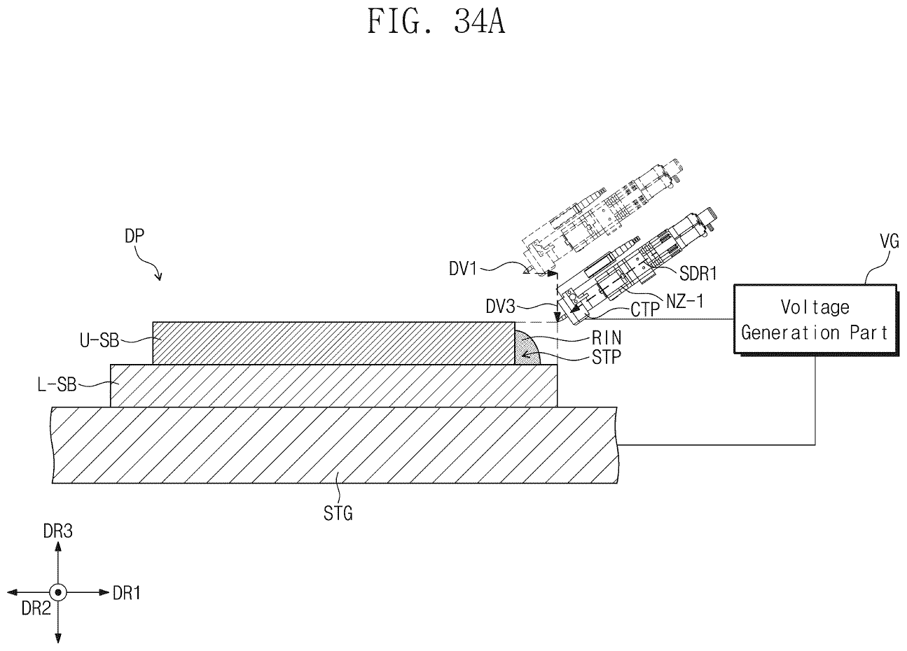

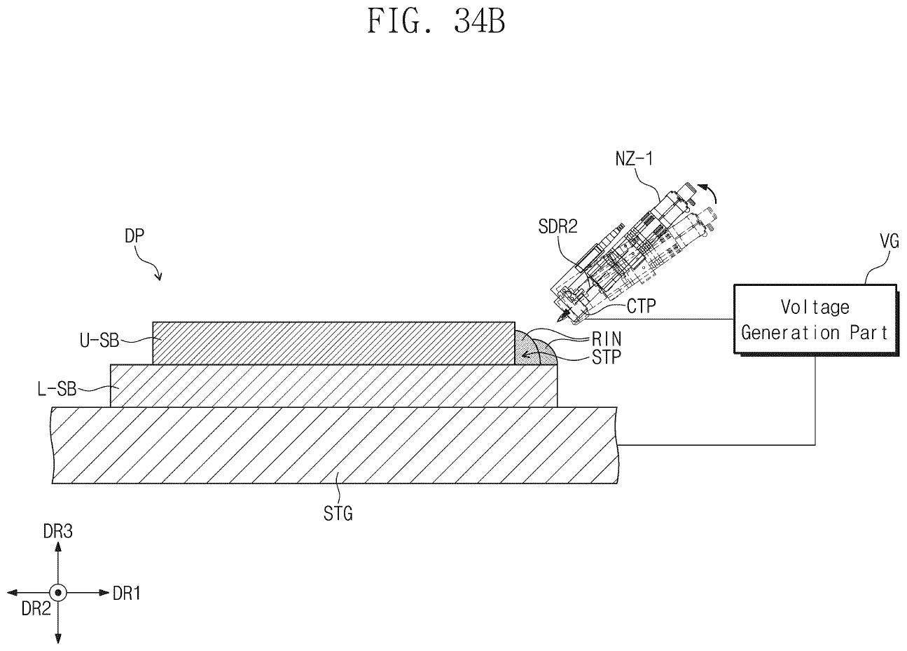

FIG. 28 is a side view of the discharge device illustrated in FIG. 26, which is disposed to be parallel to the third direction. FIG. 29 is a drawing of a discharge device that is rotated about the third direction such that a side surface of an ink inlet, illustrated in FIG. 28, is shown. FIG. 30 is a side view of the discharge device illustrated in FIG. 29, where a conductive part and a connecting part are removed therefrom.

In FIG. 28, a stage STG, disposed under the discharge device NZ-1, is exemplarily illustrated with the discharge device NZ-1. For the convenience of description, FIG. 28 illustrates that the stage STG and a display panel DP are relatively smaller than the discharge device NZ-1. In addition, a control part CON, a voltage generation part VG, the stage STG, and the display panel DP are illustrated only in FIG. 28, and are omitted in FIGS. 29 and 30.

Referring to FIGS. 28, 29, and 30, the dispensing device DPA, previously described, may further include the control part CON, the voltage generation part VG, and the stage STG. The discharge device NZ-1 may further include a cable connecting part CCB disposed on the drive part DV. The control part CON may be connected to the cable connecting part CCB through a cable (not shown). The cable connecting part CCB may be connected to the drive part DV.

The control part CON may be connected to the drive part DV, e.g. through the cable and the cable connecting part CCB, and may control the operation of the drive part DV. For example, the drive part DV may include a motor, and the control part CON may control the number of rotations per minute RPM of the motor. The motor may rotate about a rotation axis parallel to an extending direction (or length direction) of the discharge device NZ-1. The extending direction of the discharge device NZ-1 is the third direction DR3 in the embodiment of FIGS. 28 to 30.

In FIG. 28, the drive part DV, the first and second cases CS1 and CS2, the insulation part INP, the ink transfer part IMV, and the discharge part DSP may be arranged in the extending direction of the discharge device NZ-1. In FIG. 28, the drive part DV, the first and second cases CS1 and CS2, the insulation part INP, the ink transfer part IMV, and the discharge part DSP may be arranged in the third direction DR3.

The discharge part DSP may be disposed under the drive part DV, the first and second cases CS1 and CS2, the insulation part INP, and the ink transfer part IMV may be disposed between the drive part DV and the discharge part DSP. The first case CS1 may be disposed between the drive part DV and the insulation part INP. The insulation part INP may be disposed between the first case CSI and the second case CS2.

The ink inlet pipe IIT may be connected to a side surface of the second case CS2. The second case CS2 may be disposed between the insulation part INP and the ink transfer part IMV. The ink transfer part IMV may be disposed between the second case CS2 and the discharge part DSP.

The conductive part CTP may be disposed to surround the ink transfer part IMV, and connected to the ink transfer part IMV. The conductive part CTP may be disposed to surround a lower part of the ink transfer part IMV, and may thus be disposed adjacent to the discharge part DSP. However, the position of the conductive part CTP is not limited thereto, and for example, the conductive part CTP may also be connected to the discharge part DSP. For example, the conductive part CTP may include an electrically conductive metal material.

The stage STG may be disposed under the discharge part DSP. The stage STG may have a flat surface defined by the first and second directions DR1 and DR2. The display panel DP may be placed on an upper surface of the stage STG. The display panel DP may be the process object.

The voltage generation part VG may be connected to the control part CON. The control part CON may control the level of voltage generated from the voltage generation part VG. The voltage generation part VG may generate a voltage of about 1 kv to about 4 kv. The voltage generation part VG may apply a high voltage of about 1 kv to about 4 kv to the conductive part CTP, and apply a ground voltage to the stage STG. That is, the stage STG may be grounded. Therefore, an electric field may be formed from the conductive part CTP toward the stage STG.

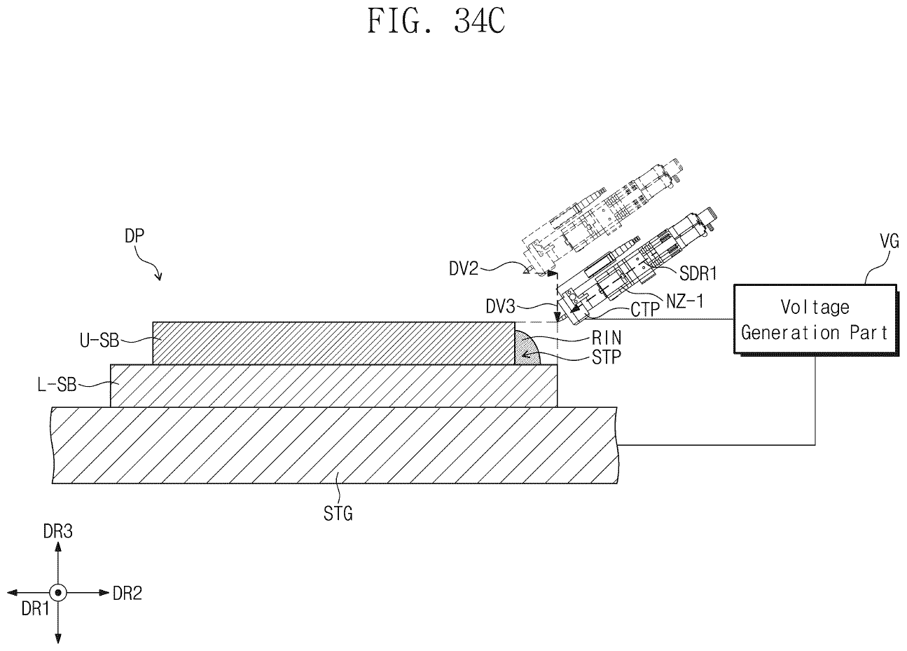

Driving power of the drive part DV (for example, rotational power of a motor) may be transferred to the ink transfer part IMV. Ink may be flowed into the ink inlet pipe IIT. Although not illustrated in the drawing, the ink inlet pipe IIT may be connected to an ink storage part, and may receive the ink from the ink storage part. The ink may be provided to the ink transfer part IMV, and the ink may be provided to the discharge part DSP according to the driving power transferred to the ink transfer part IMV. These internal configuration and operation will be described with reference to FIG. 31.

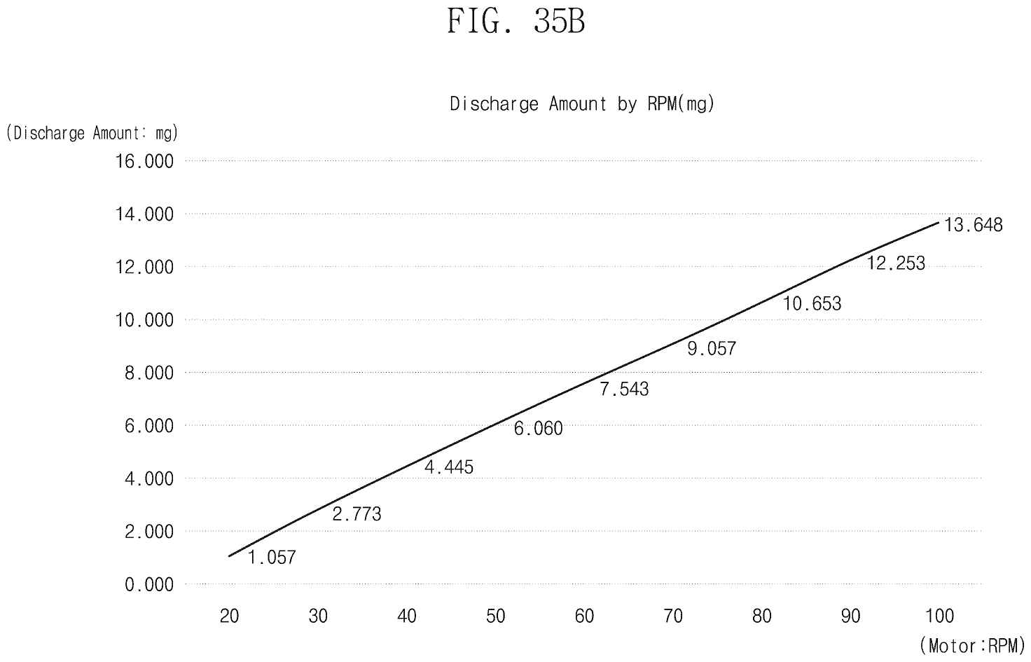

According to the operation, the discharge part DSP may discharge the ink according to the driving power of the drive part DV. The discharge part DSP may discharge the ink toward the display panel DP. In manufacturing of the display panel DP, the particular method of providing the ink to the display panel DP will be described in detail with reference to FIGS. 34A to 34D as follows.

As previously described, since a high voltage is applied to the conductive part CTP, the electric field may be formed from the conductive part CTP toward the stage STG. In this case, due to the electric field, the ink may be easily provided to the display panel DP on the stage STG. The conductive part CTP may also be omitted. In this case, the discharge part DSP may include a conductive metal material, and the voltage generation part VG may apply a voltage to the discharge part DSP.

According to an embodiment of the inventive concept, due to the power of the electric field which is formed by the voltage applied to the conductive part CTP, as well as the driving power of the drive part DV, the ink may be provided to the display panel DP more easily.

The insulation part INP may include an insulating material such as plastic. The insulation part INP may block any current that might flow from the conductive part CTP to the drive part DV according to the voltage applied to the conductive part CTP. When the current flows into the drive part DV, the drive part DV may be damaged or malfunction due to the high voltage applied to the conductive part CTP. Since the insulation part INP blocks the current that might flow from the conductive part CTP to the drive part DV, the damage and malfunction of the drive part DV may be prevented.

FIG. 31 is a drawing schematically illustrating internal configuration of the discharge device illustrated in FIG. 28.

For convenience of description, FIG. 31 depicts the external shape of the discharge device NZ-1 and a portion of the internal configuration that is related to the driving power. In addition, in FIG. 31, the internal shape of the discharge part DSP is omitted and the external shape of the discharge part DSP is simply illustrated.

Referring to FIG. 31, the discharge device NZ-1 may include a driving shaft DSFT disposed under the drive part DV. The ink transfer part IMV may include a rotor ROT and a stator SAT.

The driving shaft DSFT may be disposed in the first and second cases CS1 and CS2 and the insulation part INP. The driving shaft DSFT may be disposed between the drive part DV and the discharge part DSP. The driving shaft DSFT may be connected to the drive part DV and extend toward the discharge part DSP. The rotor ROT may be disposed between the driving shaft DSFT and the discharge part DSP. The rotor ROT may be connected to the driving shaft DSFT and extend toward the discharge part DSP.

When the drive part DV rotates, driving power of the drive part DV (for example, rotational power of a motor) may be transmitted to the driving shaft DSFT. In addition, the driving power of the drive part DV may be transmitted to the rotor ROT through the driving shaft DSFT. Accordingly, the driving shaft DSFT and the rotor ROT may be rotated by the driving part DV.

A hollow CVT, passing through the stator SAT in the third direction DR3, may be defined inside the stator SAT. The rotor ROT may be inserted in the hollow CVT defined inside the stator SAT, and may thus be disposed inside the hollow CVT. The inner circumferential surface of the hollow CVT may have a single-stage or multi-stage female thread shape. The outer circumferential surface of the rotor ROT may have a single-stage or multi-stage male thread shape corresponding to the inner circumferential surface of the stator SAT.

When the rotor ROT is disposed in the hollow CVT of the stator SAT, a transfer space MSC may be defined along an extending direction of the discharge device NZ-1. The transfer space MSC may be defined between the rotor ROT and the inner circumferential surface of the stator SAT.

Ink (not shown) may flow into the second case CS2 through the ink inlet pipe IIT to be disposed in the transfer space MSC. According to the driving power of the drive part DV, the driving shaft DSFT may rotate, and the rotor ROT may rotate according to the rotation of the driving shaft DSFT.

The rotor ROT may rotate eccentrically in the hollow CVT of the stator SAT, and may thus transfer the ink, disposed in the transfer space MSC, to the lower part. Therefore, the ink may be supplied into the discharge part DSP, and the discharge part DSP may discharge the ink. As a result, according to the driving power of the drive part DV, the discharge part DSP may discharge the ink.

As rotational power of the drive part DV becomes larger, that is, as the number of rotations per minute becomes higher, the driving shaft DSFT and the rotor ROT may rotate more rapidly, and more ink may be supplied to the discharge part DSP. Since the control part CON, previously described, controls the rotational power of the drive part DV, the amount of ink that is discharged from the discharge part DSP may be controlled.

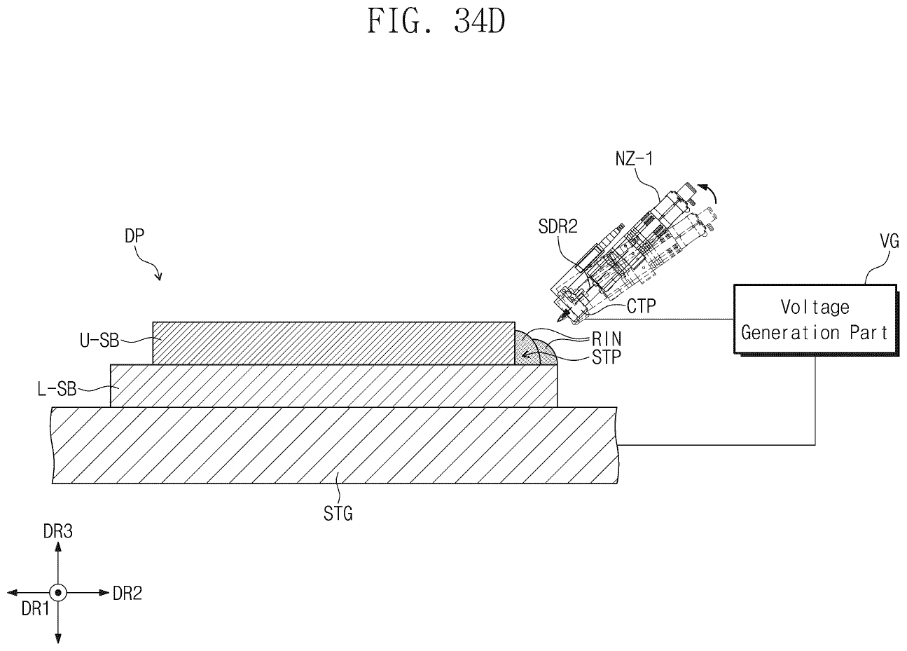

FIG. 32 is an exploded perspective view of the discharge device illustrated in FIG. 28, where the insulation part and the conductive part are separated.

FIG. 32 exemplarily illustrates a perspective view of the discharge device NZ-1 which that extends in a third direction DR3, and corresponds to FIG. 29. In addition, for the convenience of description, FIG. 32 illustrates a driving shaft DSFT in an alternate long and short dashed line.

Referring to FIGS. 28 and 32, the insulation part INP may be disposed between the first case CS1 and the second case CS2 to be coupled to the first case CS1 and the second case CS2. For example, the insulation part INP may be coupled to the first case CS1 and the second case CS2 by fastening units (not shown) such as a screw, an adhesive (not shown), or the like. For example, according to an embodiment of the inventive concept, the insulation part INP may be coupled to the first case CS1 and the second case CS2 by the fastening units.

A hole H may be defined in the insulation part INP. The hole H may be defined in the center region of the insulation part INP in the extending direction of the discharge device NZ-1. In FIG. 32, the hole H may extend through the center of the insulation part INP in the third direction DR3. The driving shaft DSFT may extend from the drive part DV to pass through the hole H. The hole H may provide a space for disposing the driving shaft DSFT.

The thickness of the insulation part INP may be smaller than the width of the insulation part INP. The thickness of the insulation part INP may be measured in the extending direction of the discharge device NZ-1 (for example, third direction DR3 in FIG. 32). As previously described, the extending direction of the discharge device NZ-1 may be defined as a direction in which the drive part DV, the first and second cases CS1 and CS2, the insulation part INP, the ink transfer part IMV, and the discharge part DSP are arranged.

The width of the insulation part INP may be defined as a value measured in a direction substantially perpendicular to the extending direction of the discharge device NZ-1. The direction perpendicular to the one direction may be a direction parallel to the insulation part INP, such as a first direction DR1 or a second direction DR2 in FIG. 32.

The insulation part INP may include a first insulation part INP1 and a second insulation part INP2 disposed on the first insulation part INP1. The first insulation part INP1 and the second insulation part INP2 may be coupled to each other by a fastening unit (not shown) such as a screw, an adhesive (not shown), or the like. For example, according to an embodiment of the inventive concept, the first insulation part INP1 and the second insulation part INP2 may be coupled to each other by the fastening unit.

The thickness of the insulation part INP and the width of the insulation part INP may be defined as values measured in a state where the first and second insulation parts INP1 and INP2 are coupled to each other. When the first insulation part INP1 and the second insulation part INP2 are coupled to each other, the edge of the first insulation part INP1 and the edge of the second insulation part INP2 may contact each other.

The first insulation part INP1 may be disposed on the second case CS2, and coupled to the second case CS2. The second insulation part INP2 may be disposed under the first case CS1, and coupled to the first case CS1.

The hole H may include a first hole H1 defined in the first insulation part INP1, and a second hole H2 defined in the second insulation part INP2. The first hole H1 may be defined in the first insulation part INP1 as an opening in the center region of the first insulation part INP1 in the extending direction of the discharge device NZ-1. The second hole H2 may be defined in the second insulation part INP2 as an opening in the center region of the second insulation part INS2 in the extending direction of the discharge device NZ-1.

In plan view, the first insulation part INP1 may have a ring shape with the first hole H1 in the center region. In addition, in plan view, the second insulation part INP2 may have a ring shape with the second hole H2 in the center region.

The first hole H1 and the second hole H2 may provide a space into which the driving shaft DSFT can extend. The driving shaft DSFT may extend through the first hole H1 and the second hole H2 between the drive part DV and the discharge part DSP.

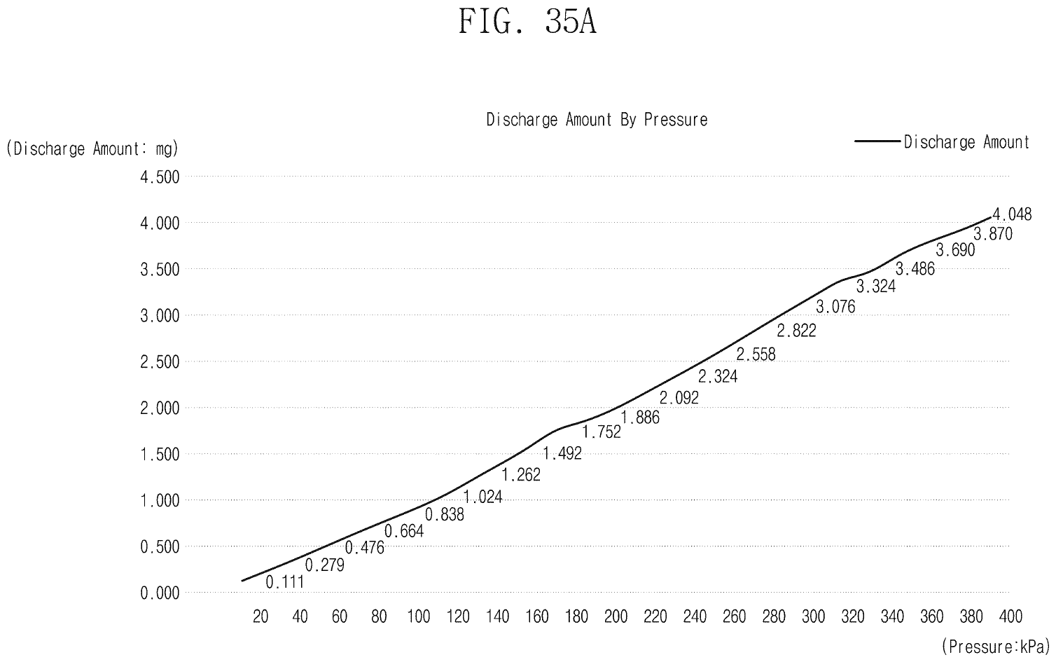

FIG. 33A is an enlarged perspective view of the insulation part illustrated in FIG. 32. FIG. 33B is a perspective view of a rear surface of the insulation part illustrated in FIG. 33A.

FIGS. 33A and 33B exemplarily illustrate that the first and second insulation parts INP1 and INP2 are arranged in a third direction DR3.

Referring to FIGS. 33A and 33B, an upper surface of the first insulation part INP1 facing the second insulation part INP2 may include a plurality of first protruding parts PT1 and a plurality of first grooves GV1 adjacent to the first protruding parts PT1. The first protruding parts PT1 may be disposed along the edge of the first insulation part INP1, and protrude toward the second insulation part INP2. With respect to FIG. 33A, the first protruding parts PT1 may protrude upward. The first grooves GV1 may be defined between the first protruding parts PT1 along the edge of the first insulation part INP1.

The first protruding parts PT1 may be disposed between the outer edge of the first insulation part INP1 and the first hole H1. The first protruding parts PT1 may be form part of a side surface of the first insulation part INP1 and a sidewall of the first hole H1, to the outer edge of the first insulation part INP1.

With respect to FIG. 33A, the first grooves GV1 may be formed such that portions of the upper surface of the first insulation part INP1 are recessed downward. Upper surfaces of the portions of the first insulation part INP1, where the first grooves GV1 are formed, may be disposed lower than upper surfaces of portions of the first insulation part INP1 where the first protruding parts PT1 are formed.

A lower surface of the second insulation part INP2, facing the first insulation part INP1, may include a plurality of second protruding parts PT2 and a plurality of second grooves GV2 adjacent to the second protruding parts PT2. The second protruding parts PT2 are disposed along the edge of the second insulation part INP2, and may protrude toward the first insulation part INP1. With respect to FIG. 33A, the second protruding parts PT2 may protrude downward. The second grooves GV2 may be defined between the second protruding parts PT2 along the edge of the second insulation part INP2.

The second protruding parts PT2 may be between the edge of the second insulation part INP2 and the second hole H2. The second protruding parts PT2 may form part of the sidewall of the second hole H2 and extend to the outer edge of the second insulation part INP2.

With respect to FIG. 33A, the second grooves GV2 may be formed such that portions of the lower surface of the second insulation part INP2 are recessed upward. Lower surfaces of the portions of the second insulation part INP2, where the second grooves are formed, may be disposed higher than lower surfaces of portions of the second insulation part INP2 where the second protruding parts PT2 are formed.

The first protruding parts PT1 may be disposed to face the second grooves GV2. The second protruding parts PT2 may be disposed to face the first grooves GV1.

When the first insulation part INP1 and the second insulation part INP2 are coupled to each other, the first protruding parts PT1 may fit with the second grooves GV2, and the second protruding parts PT2 may fit with the first grooves GV1. When the first and second protruding parts PT1 and PT2 are combined with the first and second grooves GV1 and GV2, the first insulation part INP1 and the second insulation part INP2 may be coupled to each other securely.

FIGS. 34A to 34D are drawings illustrating a manufacturing method of a display device using a dispensing device including the discharge device illustrated in FIG. 26.

FIGS. 34A to 34D are exemplarily illustrated as cross-sections of the embodiment depicted in FIGS. 24A to 24C.

Except for a discharge device NZ-1 being used, aligning operation of the discharge device NZ-1 may be the same as the aligning operation of the nozzle NZ according to operations of first to third drive parts DV1, DV2, and DV3, previously described. Therefore, description on the aligning operation of the discharge device NZ-1 will be omitted or simplified hereinafter.

Referring to FIG. 34A, a lower substrate L-SB or an upper substrate U-SB disposed on the lower substrate L-SB may rest on a stage STG. As previously described, since the upper substrate U-SB has a smaller width than that of the lower substrate L-SB, a step portion STP may form between the edge of the lower substrate L-SB and the edge of the upper substrate U-SB.

When the discharge device NZ-1 is disposed toward a side surface of the display panel DP parallel to a second direction DR2, the discharge device NZ-1 may be aligned toward the step portion STP by the first and third drive parts DV1 and DV3. As previously described, a voltage generation part VG may apply high voltage to a conductive part CTP, and the stage STG may be grounded.

Due to driving power (or rotational power) of the drive part DV and an electric field formed between the conductive part CTP and the stage STG, a resin RIN may be discharged from the discharge device NZ-1 toward the step portion STP. The resin RIN may be the ink that is previously described. The discharge device NZ-1 may be disposed in a first slope direction SDR1, so that the resin RIN may be provided to the step portion STP. The resin RIN may be more easily discharged not only by the driving power of the drive part DV but also by the electric field formed between the conductive part STP and the stage STG.

Referring to FIG. 34B, after this, the discharge device NZ-1 may rotate with respect to a tip of the nozzle NZ through a nozzle drive part NDV, previously described, and may thus be disposed in a second slope direction SDR2 that is different from the first slope direction SDR1. The discharge device NZ-1 may be disposed in the second slope direction SDR2, so that the resin RIN may be provided to the step portion STP.

Referring to FIG. 34C, after this, when the discharge device NZ-1 is disposed toward a side surface of the display panel DP parallel to a first direction DR1, the discharge device NZ-1 may be aligned toward the step portion STP by the second and third drive parts DV2 and DV3. The voltage generation part VG may apply high voltage to the conductive part CTP, and the stage STG may be grounded. The discharge device NZ-1 may be disposed in the first slope direction SDR1, so that the resin RIN may be provided to the step portion STP.

Referring to FIG. 34D, after this, the discharge device NZ-1 may be disposed in the second slope direction SDR2 through the nozzle drive part NDV previously described. The discharge device NZ-1 may be disposed in the second slope direction SDR2, so that the resin RIN may be provided to the step portion STP.

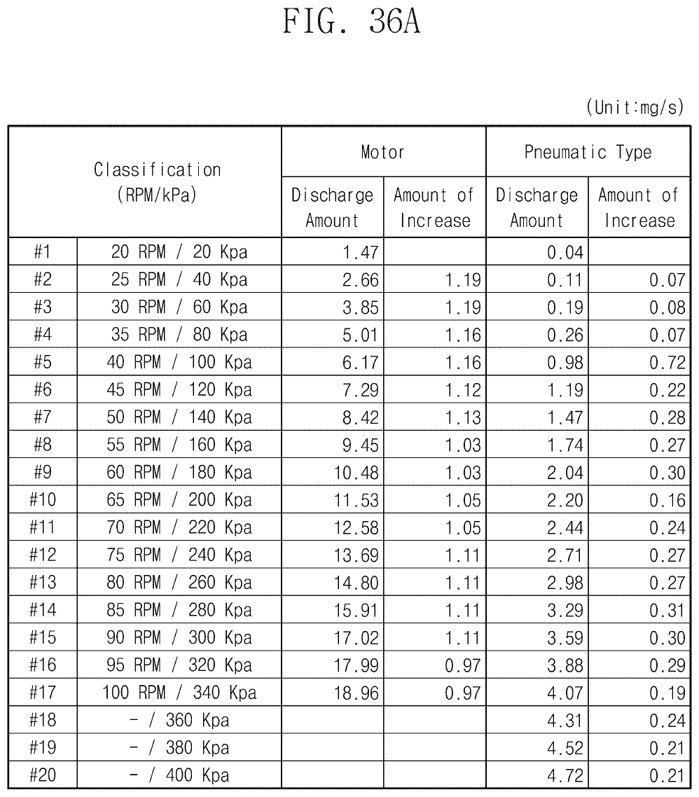

FIG. 35A shows the discharge amount of ink, discharged from a pneumatic discharge device, according to pressure. FIG. 35B shows the discharge amount of ink, discharged from a discharge device according to an embodiment of the inventive concept, according to the number of rotations per minute of a drive part.

Hereinafter, a drive part DV of a discharge device NZ-1, according to an embodiment of the inventive concept, will be referred to as a motor.

In FIG. 35A, the horizontal axis represents pressure, and the vertical axis represents the discharge amount of ink. In FIG. 35B, the horizontal axis represents the number of rotations per minute (RPM) of the motor, and the vertical axis represents the discharge amount of ink. The unit of pressure is kilopascal (kPa), and the unit of discharge amount is milligram (mg).

Referring to FIGS. 35A and 35B, the pneumatic type, which is the same as a syringe, may be defined as a type of discharging ink by pushing it out with pressure. The discharge device NZ-1, according to an embodiment of the inventive concept, may be defined as a motor type in which the ink is discharged by using the motor. In addition, the discharge device NZ-1, according to an embodiment of the inventive concept, may discharge the ink by forming the electric field, previously described.

In case of the pneumatic type, the discharge amount of ink may increase with increase in pressure. In case of the motor type, the discharge amount of ink may increase according to increase in the number of rotations per minute of the motor. The discharge amount of ink may be larger in the motor type than in the pneumatic type.

The pneumatic discharge device and the motorized discharge device NZ-1 according to an embodiment of the inventive concept may discharge ink while moving. When the pneumatic discharge device and the motorized discharge device NZ-1 according to an embodiment of the inventive concept move in the same speed, the discharge amount of ink of the motorized discharge device NZ-1, according to an embodiment of the inventive concept, may be about 1.5 to about 3 times the discharge amount of ink of the pneumatic discharge device.

When the pneumatic discharge device and the motorized discharge device NZ-1 according to an embodiment of the inventive concept discharge the same amount of ink, the moving speed of the motorized discharge device NZ-1, according to an embodiment of the inventive concept, may be higher than the moving speed of the pneumatic discharge device.

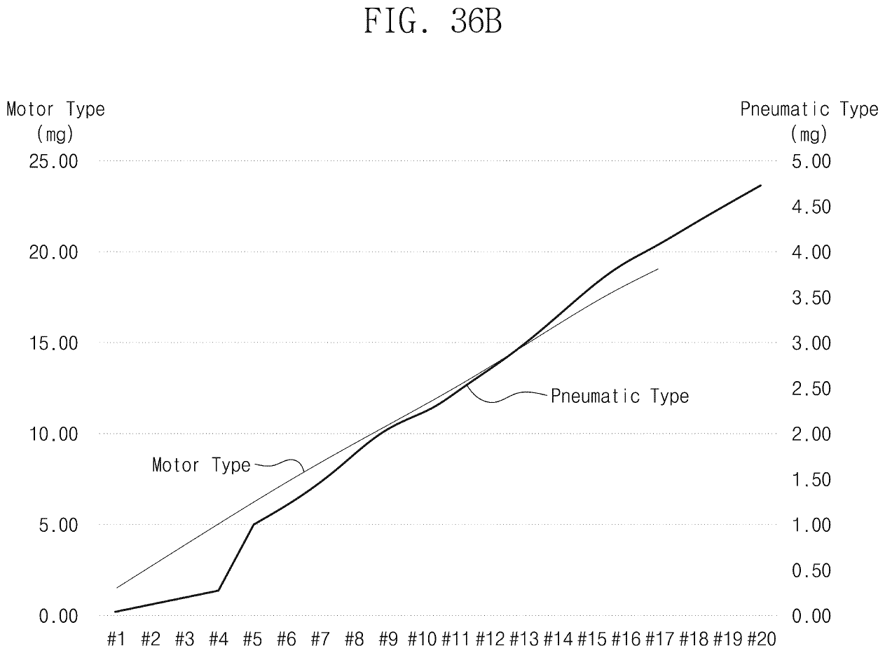

FIG. 36A is a diagram showing the discharge amount of ink and the amount of increase in the discharged ink in a table when the number of rotations per minute of a motor of a motorized discharge device and the pressure of a pneumatic discharge device are increased. FIG. 36B is a diagram showing the values of the table illustrated in FIG. 36A in a graph.

FIGS. 36A and 36B may show different results of experiment from those in FIGS. 35A and 35B.

In FIGS. 36A and 36B, #1 to #20 represent the order of experiment according to increase in the number of rotations per minute of a motor and increase in pressure. In FIG. 36A, the amount of increase may be defined as the difference in the amount of discharge between the previous experimental stage and current experimental stage.

In FIG. 36B, the vertical axis on the left side represents the discharge amount of ink of a motor type, and the vertical axis on the right side represents the discharge amount of a pneumatic type.

Referring to FIGS. 36A and 36B, in case of the motor type, the amount of increase may be approximately similar with each other, and as illustrated in FIG. 36B, the discharge amount of ink may increase approximately linearly. However, in case of the pneumatic type, the amount of increase may not be constant, compared to the motor type, so that the discharge amount of ink, as illustrated in FIG. 36B, may not increase linearly.

When the discharge amount of ink increases linearly, the discharge amount of ink may be easily controlled. That is, since the discharge amount of ink increases linearly according to increase in the number of rotations per minute of the motor, the discharge amount of ink, according to the number of rotations per minute of the motor, may be easily predicted. Therefore, according to an embodiment of the inventive concept, the discharge amount of ink may be easily controlled by controlling the number of rotations per minute of the motor.

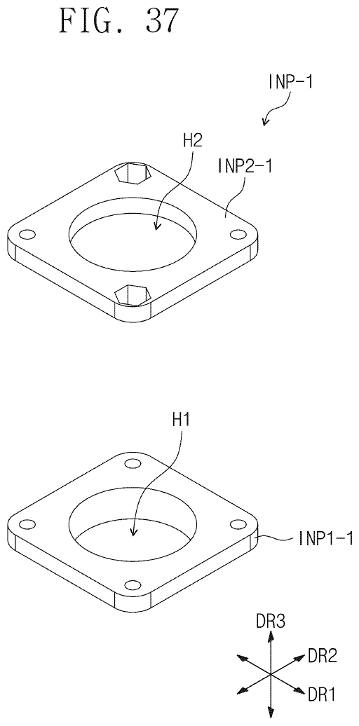

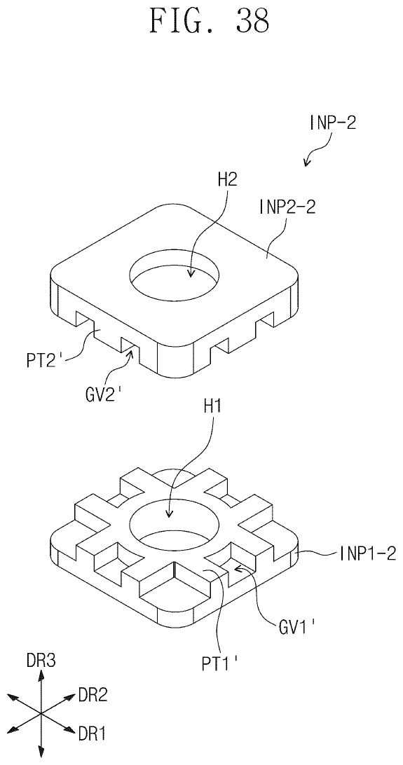

FIGS. 37 and 38 depict components of an insulation part according to another embodiment of the inventive concept.

FIGS. 37 and 38 are perspective views.

Hereinafter, components of insulation parts INP-1 and INP-2 illustrated in FIGS. 37 and 38, which are different from those of the insulation part INP illustrated in FIG. 33A, will be mainly described.

Referring to FIG. 37, the insulation part INP-1 may include a first insulation part INP1-1 and a second insulation part INP2-1 disposed on the first insulation part INP1-1. Unlike the first and second insulation parts INP1 and INP2 illustrated in FIG. 33A, the first and second insulation parts INP1-1 and INP2-1 may not include protruding parts and grooves, and may have a flat shape.

Referring to FIG. 38, the insulation part INP-2 may include a first insulation part INP1-2 and a second insulation part INP2-2 disposed on the first insulation part INP1-2. An upper surface of the first insulation part INP1-2 may include a plurality of first protruding parts PT1′ and a plurality of first grooves GV1′ defined between the first protruding parts PT1′ along the edge of the first insulation part INP1-2. A lower surface of the second insulation part INP2-2 may include a plurality of second protruding parts PT2′ and a plurality of second grooves GV2′ defined between the second protruding parts PT2′ along the edge of the second insulation part INP2-2.

The first and second insulation parts INP1 and INP2 illustrated in FIG. 33A may each include two protruding parts PT1 and PT2 and two grooves GV1 and GV2, but an embodiment of the inventive concept is not limited thereto. For example, as illustrated in FIG. 38, the first insulation part INP1-2 and the second insulation part INP2-2 may include more than two protruding parts PT1′ and PT2′ and more than two grooves GV1′ and GV2′.

According to an embodiment of the inventive concept, a nozzle drive part of a dispensing device may rotate a nozzle with respect to the tip of the nozzle from which a resin is discharged, thereby aligning the nozzle. Therefore, an aligning operation of the nozzle may be performed more easily.

According to an embodiment of the inventive concept, since a high voltage is applied to a conductive part connected to a discharge device, and a stage is grounded, an electric field may be formed between the conductor and the stage. Due to the electric field, ink may be more easily provided from a discharge part to a display panel on the stage. In addition, an insulation part may be disposed between the conductive part and a drive part, and the insulation part may block current flowing from the conductive part to the drive part. As a result, it may be possible to prevent malfunction of the drive part.

Although the embodiments of the inventive concept have been described, it is understood that the inventive concept should not be limited to these embodiments but various changes and modifications can be made by one ordinary skilled in the art within the spirit and scope of the inventive concept as hereinafter claimed. In addition, the embodiments of the inventive concept disclosed herein are not intended to limit the technical idea of the inventive concept, but it should be construed all technologies within the scope of the following claims and equivalents thereof are included in the scope of rights of the inventive concept.

What is claimed is:

1. A dispensing device comprising:
a rotation drive part;
a curved rail part connected to the rotation drive part in a first direction;
a curved movement part coupled to a lower portion of the curved rail part; and
a nozzle connected to the curved movement part,
wherein the nozzle rotates with respect to a tip of the nozzle.

2. The dispensing device of claim 1, wherein the nozzle rotates about a rotation axis that coincides with the tip of the nozzle and extends in a second direction crossing the first direction.

3. The dispensing device of claim 2, wherein the nozzle comprises:
a nozzle body; and
a discharge part connected to an end of the nozzle body and having
a tip that coincides with the rotation axis.

4. The dispensing device of claim 2, wherein the nozzle is inclined with respect to the first direction.

5. The dispensing device of claim 4, wherein a rotation angle of the nozzle with respect to the first direction is about 30° to about 45°.

6. The dispensing device of claim 2, wherein when viewed from the second direction, the curved movement part moves in a curve direction defined by a predetermined arc, with respect to the curved rail part.

7. The dispensing device of claim 6, wherein the rotation axis is defined as a center point of a circle that includes the arc.

8. The dispensing device of claim 6, wherein when viewed from the second direction, the curved rail part comprises a curved rail having the predetermined arc, and the curved movement part is coupled to the curved rail to move along the curved rail.

9. The dispensing device of claim 1, further comprising a drive bar extending from the rotation drive part in the first direction and disposed inside the curved rail part to be connected to the curved movement part.

10. The dispensing device of claim 1, wherein the nozzle is connected to a first side of the curved movement part that is opposed to a second side of the curved movement part that is adjacent to the rotation drive part.

11. The dispensing device of claim 1, wherein the nozzle discharges a resin having a black color.

12. The dispensing device of claim 11, wherein the nozzle discharges the resin toward a step portion on an edge of a display panel.

13. The dispensing device of claim 12, wherein the nozzle discharges the resin multiple times toward the step portion while rotating around the tip of the nozzle.

14. The dispensing device of claim 1, further comprising:
a first drive part;
a second drive part; and
a third drive part disposed under the first and second drive parts,
wherein the rotation drive part is disposed under the third drive part,
wherein the rotation drive part, the curved rail part, the curved movement part, the nozzle, and the third drive part are moved in the first direction by the first drive part, and moved, by the second drive part, in a second direction crossing the first direction, and
wherein the rotation drive part, the curved rail part, the curved movement part, and the nozzle are moved, by the third drive part, in a third direction crossing a plane defined by the first and second directions.

15. The dispensing device of claim 14, further comprising a connection plate disposed under and connected to the first and second drive parts,
wherein the third drive part is connected to a lower surface of the connection plate,
the first drive part moves the connection plate in the first direction, and the second drive part moves the connection plate in the second direction.

16. The dispensing device of claim 14, further comprising:
a first movement part connected to the third drive part in the first direction and configured to move in the first direction; and
a second movement part coupled to move in the third direction with respect to the first movement part,
wherein the curved rail part is connected to the second movement part.

17. The dispensing device of claim 16, further comprising a connection part connected to the second movement part, wherein the curved rail part is disposed under and connected to the connection part.

18. A dispensing device comprising:
a nozzle drive part; and
a nozzle connected to the nozzle drive part,
wherein the nozzle drive part rotates the nozzle with respect to a tip of the nozzle.

19. The dispensing device of claim 18, wherein the nozzle drive part comprises:
a rotation drive part;
a curved rail part connected to the rotation drive part in a first direction;
a curved movement part coupled to a lower portion of the curved rail part and configured to move in a predetermined arc with respect to the curved rail part; and
a nozzle connected to the curved movement part,
wherein the nozzle rotates with respect to the tip of the nozzle.

20. The dispensing device of claim 19, further comprising:
a first drive part;
a second drive part; and
a third drive part disposed under the first and second drive parts,
wherein the rotation drive part is disposed under the third drive part,
wherein the rotation drive part, the curved rail part, the curved movement part, the nozzle, and the third drive part are moved in the first direction by the first drive part, and moved, by the second drive part, in a second direction crossing the first direction, and
wherein the rotation drive part, the curved rail part, the curved movement part, and the nozzle are moved, by the third drive part, in a third direction crossing a plane defined by the first and second directions.

21. A discharge device comprising:
a drive part;
a discharge part disposed under the drive part and configured to discharge ink according to driving power of the drive part; and
an insulation part disposed between the drive part and the discharge part,
wherein the drive part, the discharge part, and the insulation part are arranged in an extending direction, and a thickness of the insulation part in the extending direction is smaller than a width of the insulation part in a direction perpendicular to the extending direction.

22. The discharge device of claim 21, further comprising a through-hole in a center region of the insulation part extending in the extending direction.

23. The discharge device of claim 21, wherein the insulation part comprises:
a first insulation part; and
a second insulation part disposed on the first insulation part and coupled to the first insulation part, and
wherein the thickness and the width of the insulation part are measured in a state where the first and second insulation parts are coupled to each other.

24. The discharge device of claim 23, wherein in the one direction, a first hole passing through a center portion of the first insulation part is defined in the first insulation part, and a second hole passing through a center portion of the second insulation part is defined in the second insulation part.

25. The discharge device of claim 24, further comprising:
a driving shaft disposed between the drive part and the discharge part to pass through the first hole and the second hole; and
a rotor disposed between the driving shaft and the discharge part.

26. The discharge device of claim 23, wherein an upper surface of the first insulation part, facing the second insulation part, comprises:
a plurality of first protruding parts disposed along an outer edge of the first insulation part, and protruding toward the second insulation part; and
a plurality of first grooves defined between the first protruding parts along the outer edge of the first insulation part.

27. The discharge device of claim 26, wherein a lower surface of the second insulation part, facing the first insulation part, comprises:
a plurality of second protruding parts disposed along an outer edge of the second insulation part and protruding toward the first insulation part; and
a plurality of second grooves defined between the second protruding parts along the outer edge of the second insulation part.

28. The discharge device of claim 27, wherein the first protruding parts face the second grooves, and the second protruding parts face the first grooves.

29. The discharge device of claim 21, wherein the drive part comprises a motor configured to rotate about a rotation axis parallel to the one direction.

30. The discharge device of claim 21, further comprising a conductive part that is adjacent to the discharge part and connected to receive a voltage.

31. The discharge device of claim 30, wherein the conductive part receives a voltage of about 1 kv to about 4 kv, and a stage, which is disposed under the discharge part and on which a display panel is placed, is grounded.

32. The discharge device of claim 30, wherein the insulation part blocks current flowing from the conductive part to the drive part.

33. A manufacturing method of a display panel, comprising:
providing, on a stage, a lower substrate and an upper substrate having a smaller width than the lower substrate and disposed on the lower substrate;
pointing a discharge device toward a step portion formed by an edge of the lower substrate and an edge of the upper substrate; and
discharging ink from the discharge device to the step portion,
wherein the discharge device includes
a drive part,
a discharge part disposed under the drive part and configured to discharge ink according to driving power of the drive part, and
an insulation part disposed between the drive part and the discharge part,
wherein the drive part, the discharge part, and the insulation part are arranged in an extending direction, and a thickness of the insulation part in the extending direction is smaller than a width of the insulation part in a direction perpendicular to the extending direction.

34. The manufacturing method of claim 33, wherein the discharge device further comprises a conductive part adjacent to the discharge part.

35. The manufacturing method of claim 34, further comprising:
applying a voltage to the conductive part; and
grounding the stage.

36. The manufacturing method of claim 35, wherein the insulation part blocks current flowing from the conductive part to the drive part.

37. The manufacturing method of claim 33, wherein the insulation part comprises:
a first insulation part; and
a second insulation part disposed on the first insulation part and coupled to the first insulation part, and
wherein the thickness and the width of the insulation part are defined as values measured in a state where the first and second insulation parts are coupled to each other.

38. The manufacturing method of claim 37, wherein an upper surface of the first insulation part, facing the second insulation part, comprises:
a plurality of first protruding parts disposed along an edge of the first insulation part, and protruding toward the second insulation part; and
a plurality of first grooves defined between the first protruding parts along the edge of the first insulation part,
wherein a lower surface of the second insulation part, facing the first insulation part, comprises:
a plurality of second protruding parts disposed along an edge of the second insulation part, and protruding toward the first insulation part; and
a plurality of second grooves defined between the second protruding parts along the edge of the second insulation part, and
wherein the first protruding parts face the second grooves, and the second protruding parts face the first grooves.
